(19) United States
(12) Patent Application Publication
(10) Pub. No.: US 2026/0062005 A1
(43) Pub. Date: Mar. 5, 2026

(54) VEHICLE CONTROLLER, VEHICLE CONTROL METHOD, AND NON-TRANSITORY COMPUTER READABLE STORAGE MEDIUM

(71) Applicant: DENSO CORPORATION, Kariya-city (JP)

(72) Inventors: Takuya KUME, Kariya-city (JP); Kazuki IZUMI, Kariya-city (JP)

(21) Appl. No.: 19/380,654

(22) Filed: Nov. 5, 2025

Related U.S. Application Data
(63) Continuation of application No. PCT/JP2024/013964, filed on Apr. 4, 2024.

(30) Foreign Application Priority Data
May 17, 2023 (JP) 2023-081857
Oct. 5, 2023 (JP) 2023-173909

(51) Int. Cl. B60W 30/18; B60W 50/14; B60W 60/00

(52) U.S. Cl. CPC B60W 30/18009; B60W 50/14; B60W 60/001; B60W 60/0055; B60W 2540/215; B60W 2552/10; B60W 2554/4041

(57) ABSTRACT

A vehicle controller is adapted to a host vehicle having a driving control function that supports or substitutes for a driver in a driving operation of the host vehicle. The vehicle controller includes at least one of (i) a circuit and (ii) a processor with a memory storing computer program code executable by the processor. The vehicle controller recognizes a driving plan of the host vehicle that is utilized by the driving control function, and executes a route guidance notification in different modes when execution of U-turn control is planned in the driving plan, compared to when the execution of the U-turn control is not planned in the driving plan.

### CROSS REFERENCE TO RELATED APPLICATIONS

The present application is a continuation application of International Patent Application No. PCT/JP2024/013964 filed on Apr. 4, 2024, which designated the U.S. and claims the benefit of priority from Japanese Patent Application No. 2023-081857, filed on May 17, 2023, and Japanese Patent Application No. 2023-173909, filed on Oct. 5, 2023. The entire disclosures of all of the above applications are incorporated herein by reference.

### TECHNICAL FIELD

The present disclosure relates to a vehicle controller, a vehicle control method, and a non-transitory computer readable storage medium.

### BACKGROUND

Vehicle control technology may be used in a host vehicle equipped with a driving control function that assists or substitutes a driver's driving operation.

A method may be provided for generating a route plan for an autonomous vehicle. For example, the vehicle control technology may include a U-turn scenario as one of driving scenarios based on a planned route.

### SUMMARY

The present disclosure describes a vehicle controller, a vehicle control method, and a non-transitory computer readable storage medium, each of which may execute a route guidance notification in different modes when U-turn control is planned in a driving plan, compared to when the U-turn control is not planned in the driving plan.

### BRIEF DESCRIPTION OF DRAWINGS

FIG. 1 illustrates the overall view of an in-vehicle network including an autonomous driving ECU and an HMI control unit according to a first embodiment of the present disclosure.

FIG. 2 illustrates the details of the autonomous driving ECU.

FIG. 3 illustrates U-turn control executed by the autonomous driving ECU.

FIG. 4 illustrates offset control when making a U-turn at an intersection.

FIG. 5 illustrates the offset control when making a U-turn at a connecting road.

FIG. 6 illustrates the U-turn control when the vehicle veers to an outer lane.

FIG. 7 illustrates the status of a host vehicle for providing U-turn route guidance.

FIG. 8 illustrates the status of the host vehicle for providing right-turn route guidance.

FIG. 9 illustrates the status of the host vehicle when making a U-turn without stopping.

FIG. 10 illustrates the status of the host vehicle when a multi-point turn occurs.

FIG. 11 is a flowchart that illustrates the details of an inquiry process performed by the autonomous driving ECU and HMI control unit.

FIG. 12 is a flowchart showing the details of a travel plan generation process performed by the autonomous driving ECU.

FIG. 13 is a flowchart showing the details of a U-turn notification process performed by the autonomous driving ECU and HMI control unit.

FIG. 14 is a flowchart showing the details of a multi-point turn execution process performed by the autonomous driving ECU.

FIG. 15 is a flowchart showing the details of a permission determination process performed by the autonomous driving ECU according to a second embodiment of the present disclosure.

FIG. 16 is a flowchart showing the details of the inquiry process performed by the autonomous driving ECU and HMI control unit.

FIG. 17 is a flowchart showing the details of the travel plan generation process performed by the autonomous driving ECU.

FIG. 18 is a flowchart showing the details of a restriction lifting process performed by the autonomous driving ECU according to a third embodiment of the present disclosure.

### DETAILED DESCRIPTION

When a host vehicle, which is an autonomous vehicle, performs a U-turn based on a U-turn scenario, the host vehicle may change its direction of travel significantly more than when performing other driving controls, such as turning right or left. As a result, passengers are more likely to feel uneasy about the behavior of the host vehicle when performing U-turn maneuvers.

According to a first aspect of the present disclosure, a vehicle controller is adapted to a host vehicle equipped with a driving control function that supports or substitutes for a driver in a driving operation of the host vehicle. The vehicle controller includes: a plan recognition unit that acquires a driving plan of the host vehicle that is utilized by the driving control function; and a notification execution unit that executes a route guidance notification in different modes when U-turn control is planned in the driving plan, compared to when the U-turn control is not planned in the driving plan.

According to a second aspect of the present disclosure, a vehicle control method is adapted to a host vehicle equipped with a driving control function that supports or substitutes for a driver in a driving operation of the host vehicle. The vehicle control method includes: acquiring a driving plan of the host vehicle that is utilized by the driving control function; and executing a route guidance notification in different modes when U-turn control is planned in the driving plan, compared to when the U-turn control is not planned in the driving plan.

In the above-mentioned aspects, the route guidance notifications for when U-turn control is planned in the travelling plan used by the driving control function are performed in a different manner compared to when U-turn control is not planned. Therefore, passengers of the host vehicle can become aware of the planned U-turn control through route guidance notifications that differ from the usual ones. As a result, it becomes possible to alleviate the anxiety of passengers when U-turn control is executed.

The following describes several embodiments with reference to the drawings. In addition, in each embodiment, corresponding components may be denoted by the same reference numerals, and redundant explanations may be omitted. In cases where only a part of the configuration is described in each embodiment, other parts of the configuration can be applied from the configurations described in other previously explained embodiments. In addition to the explicitly stated combinations of configurations in the description of each embodiment, parts of the configurations from multiple embodiments can be combined, as long as there are no specific issues with such combinations, even if not explicitly mentioned.

### First Embodiment

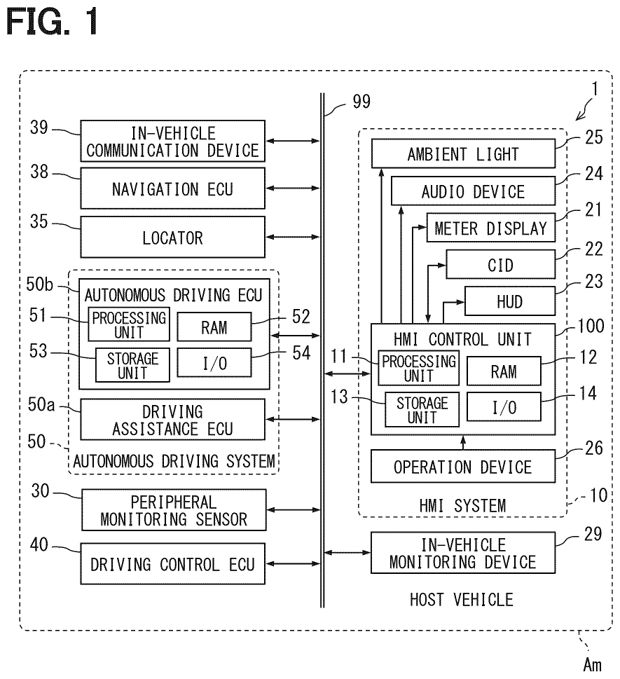

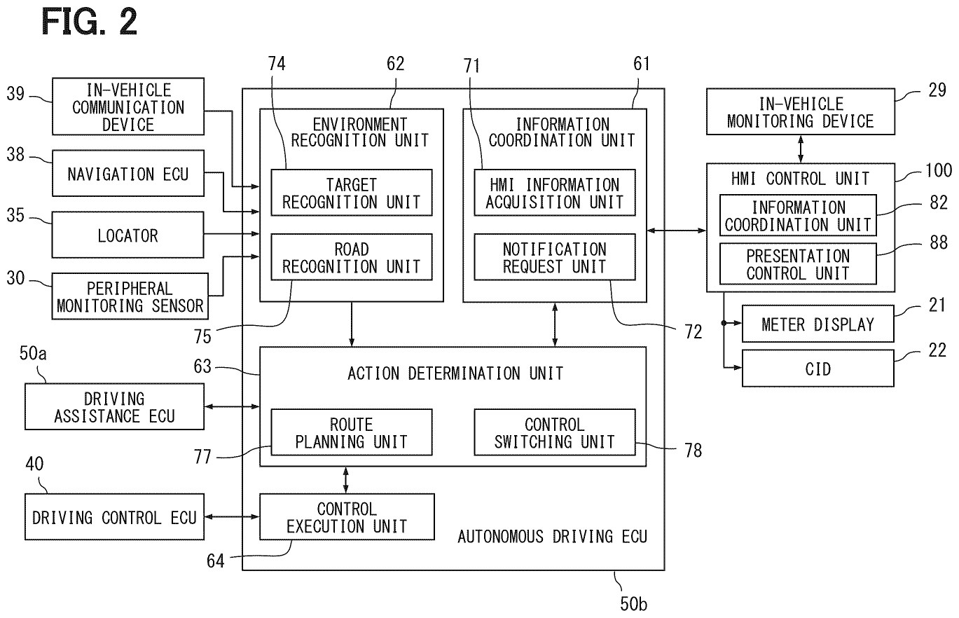

Functions of a vehicle controller according to a first embodiment of the present disclosure are implemented by an autonomous driving ECU (Electronic Control Unit) 50b shown in FIG. 1 and FIG. 2. An autonomous driving ECU 50b is adapted to a vehicle (hereinafter referred to as a host vehicle Am) together with a driving assistance ECU 50a. The autonomous driving ECU 50b and the driving assistance ECU 50a, among others, are included in the autonomous driving system 50 of the host vehicle Am. With the installation of the autonomous driving system 50, the host vehicle Am becomes an autonomous vehicle equipped with autonomous driving functions (driving control functions) and is able to travel autonomously through the use of these autonomous driving functions (autonomous travel control).

The driving assistance ECU 50a is an onboard ECU that realizes driving assistance functions to support the driver's driving operations within the autonomous driving system 50. The driving assistance ECU 50a enables advanced driving assistance or partial autonomous driving at approximately Level 2 as defined by the Society of Automotive Engineers (SAE) in the United States. The autonomous driving implemented by the driving assistance ECU 50a requires the driver to visually monitor the surroundings of the host vehicle, making it an autonomous driving system with the obligation for the driver to oversee the vehicle's surroundings. For example, driving assistance functions such as ACC (Adaptive Cruise Control), LTC (Lane Trace Control), and LCA (Lane Change Assist) are implemented by the driving assistance ECU 50a.

The autonomous driving ECU 50b is an onboard ECU that realizes autonomous driving functions capable of substituting the driver's driving operations. The term “onboard” may also be referred to as a term “in-vehicle” in the present disclosure. The autonomous driving ECU 50b is capable of implementing Level 3 or higher autonomous driving, where the system takes primary control. The Level 3 autonomous driving implemented by the autonomous driving ECU 50b allows for eyes-off driving, where the driver is not required to monitor the host vehicle's surroundings.

The autonomous driving ECU 50b may be capable of implementing Level 4 or higher autonomous driving. Level 4 autonomous driving is fully autonomous driving in which all driving tasks are performed by the system, and no request for the driver to take over is made, allowing for brain-off driving. Additionally, the autonomous driving ECU 50b performs Level 2 autonomous driving, either hands-on or hands-off, under traffic conditions where pedestrians and other vehicles are mixed with the vehicle on general roads excluding highways, with the driver monitoring the surroundings.

In the autonomous driving system 50, the control state of the autonomous driving function is switched among multiple modes, including at least the driver assistance control with a surrounding monitoring obligation by the driving assistance ECU 50a or the autonomous driving ECU 50b, and the autonomous driving control without a surrounding monitoring obligation by the autonomous driving ECU 50b. In the following description, the Level 2 or lower autonomous driving control by the driving assistance ECU 50a or the autonomous driving ECU 50b is referred to as “driver assistance control,” and the Level 3 or higher autonomous driving control by the autonomous driving ECU 50b is referred to as “autonomous driving control.”

During the autonomous driving period in which the host vehicle Am is driven under the autonomous driving control of the autonomous driving ECU 50b, specific non-driving activities (hereinafter referred to as “secondary tasks”) predefined in advance may be permitted for the driver. The secondary tasks are legally permitted for the driver until the occurrence of a driver takeover request, which is managed by the autonomous driving ECU 50b in conjunction with the Human Machine Interface (HMI) control unit 100. For example, activities such as watching entertainment content like videos, operating devices such as smartphones, and eating are considered as potential secondary tasks.

The driving assistance ECU 50a and the autonomous driving ECU 50b are communicatively connected to the communication bus 99 of the in-vehicle network 1 installed in the host vehicle Am. Connected to the communication bus 99 are an in-vehicle monitoring device 29, a peripheral monitoring sensor 30, a locator 35, a navigation ECU 38, an in-vehicle communication device 39, a driving control ECU 40, and the HMI control unit 100, among others. These nodes connected to the communication bus 99 are capable of communicating with each other. Certain nodes among these ECUs and other devices may be directly electrically connected to each other, allowing them to communicate without using the communication bus 99.

The in-vehicle monitoring device 29 includes multiple in-vehicle cameras that capture the interior of the host vehicle Am, and a control unit that controls these multiple in-vehicle cameras. The in-vehicle cameras may be visible light cameras or near-infrared cameras combined with a near-infrared light source. At least one of the multiple in-vehicle cameras is positioned to capture the occupant (driver) seated in the driver's seat and functions as a driver monitor. The in-vehicle monitoring device 29 provides the captured images from the in-vehicle cameras, or the analysis results obtained from image analysis of the captured images, to the HMI control unit 100 or the autonomous driving ECU 50b as in-vehicle monitoring information. The in-vehicle monitoring information includes driver status information indicating the position of the driver's eye point and the direction of the driver's gaze.

The peripheral monitoring sensor 30 is an autonomous sensor that monitors the surrounding environment of the host vehicle Am. The peripheral monitoring sensor 30 includes, for example, one or more of a camera unit, a millimeter-wave radar, a LIDAR, and a sonar. The peripheral monitoring sensor 30 is capable of detecting moving objects and stationary objects within the detection range around the host vehicle. The peripheral monitoring sensor 30 provides detection information of objects around the host vehicle to the driving assistance ECU 50a, the autonomous driving ECU 50b, and other related systems. Additionally, the peripheral monitoring sensor 30 provides the HMI control unit 100 with video footage of the host vehicle's surroundings (hereinafter referred to as peripheral monitoring video) captured by the camera unit.

The locator 35 is configured to include a GNSS (Global Navigation Satellite System) receiver and an inertial sensor, among other components. The locator 35 combines positioning signals received from multiple positioning satellites via the GNSS receiver, measurement results from the inertial sensor, and vehicle speed information output to the communication bus 99 to sequentially determine the position and direction of the host vehicle Am. The locator 35 sequentially outputs the position information and orientation information of the host vehicle Am, based on the positioning results, to the communication bus 99 as locator information.

The locator 35 further includes a map database that stores map data. The map database is primarily included in a large-capacity storage medium that stores a multitude of 3D map data and 2D map data. The 3D map data is a so-called High Definition (HD) map, which includes road information necessary for autonomous driving. The locator 35 reads the map data around the current position from the map database and provides the map data, along with the locator information, to the driving assistance ECU 50a and the autonomous driving ECU 50b, among others.

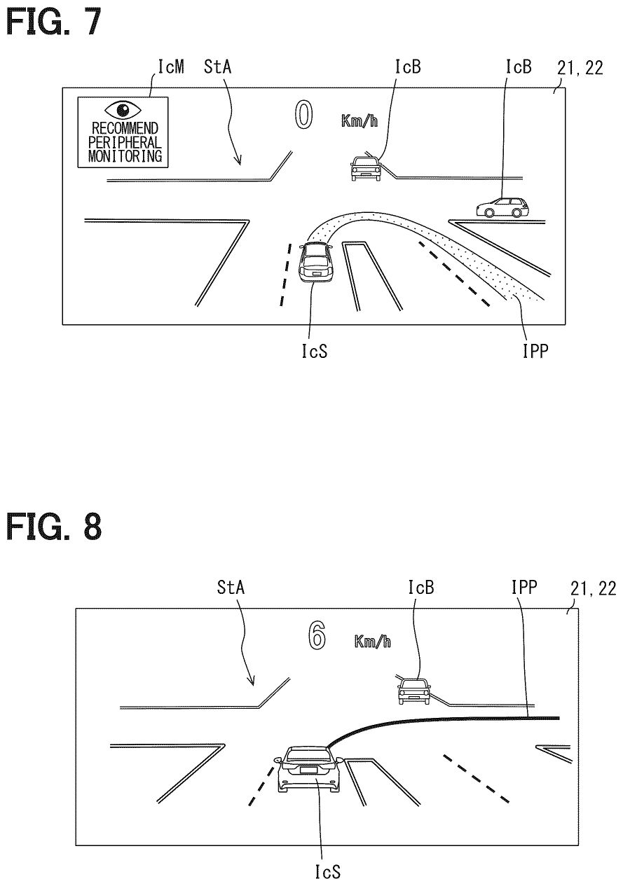

The navigation ECU 38 acquires the destination information specified by the driver or other occupants based on the operation information obtained from the HMI control unit 100. The navigation ECU 38 acquires the vehicle position information and direction information from the locator 35 and sets the route from the current position to the destination. The navigation ECU 38 provides the route information indicating the set route to the destination to the driving assistance ECU 50a, the autonomous driving ECU 50b, and the HMI control unit 100, among others. The navigation ECU 38 collaborates with the HMI system 10, described later, to provide route guidance to the destination by combining screen displays and voice messages, notifying the driver of the traveling direction of the host vehicle Am at intersections, branching points, and the like (see FIG. 7 and FIG. 8, etc.).

Here, user terminals such as smartphones and tablets may be connected to the in-vehicle network 1 or the HMI control unit 100. These user terminals can replace the locator 35 and provide vehicle position information, direction information, and map data to the driving assistance ECU 50a and the autonomous driving ECU 50b, among others. Furthermore, the user terminals can replace the navigation ECU 38 and provide route information to the destination to the driving assistance ECU 50a, the autonomous driving ECU 50b, and the HMI control unit 100, among others. Additionally, the user terminals may replace the HMI system 10 described later, or work together with the HMI system 10, to play video content and the like.

The in-vehicle communication device 39 is an external communication unit mounted on the host vehicle Am and functions as a V2X (Vehicle to Everything) communication device. The in-vehicle communication device 39 transmits and receives information via wireless communication with roadside units installed along the road. As an example, the in-vehicle communication device 39 receives traffic congestion information and traffic regulation information from the roadside units. The traffic congestion information and traffic regulation information may be, for example, VICS (registered trademark) information or the like. The in-vehicle communication device 39 may further receive signal information indicating the lighting patterns of traffic signals, as well as detection information of stopped vehicles, parked vehicles, pedestrians, cyclists, and the like from the roadside units. The in-vehicle communication device 39 provides the received traffic congestion information, traffic regulation information, signal information, and detection information to the navigation ECU 38, the autonomous driving ECU 50b, and the HMI control unit 100, among others.

The driving control ECU 40 is an electronic control unit primarily including a microcontroller. The driving control ECU 40 has at least the functions of a brake control ECU, a drive control ECU, and a steering control ECU. The driving control ECU 40 continuously performs brake force control for each wheel, output control of the in-vehicle power source, and steering angle control based on one of the following: operation commands from the driver's driving operations, control commands from the driving assistance ECU 50a, or control commands from the autonomous driving ECU 50b.

The HMI control unit 100, multiple display devices, an audio device 24, an ambient light 25, and an operation device 26 are included in the HMI system 10. The HMI system 10 is equipped with an input interface function that accepts operations from occupants such as the driver of the host vehicle Am, and an output interface function that presents information to the driver.

The display device presents information to the driver through visual means such as image display. The display devices include a meter display 21, a center information display (hereinafter referred to as CID) 22, and a head-up display (hereinafter referred to as HUD) 23. The meter display 21 and the HUD 23 are display devices primarily used to present information to the driver. The CID 22 is a display device capable of presenting information not only to the driver but also to other occupants (passengers) in the vehicle. The CID 22 has a touch panel function and detects touch operations on the display screen by the driver or other occupants.

The audio device 24 is equipped with multiple speakers installed inside the vehicle cabin. The audio device 24 plays notification sounds or voice messages inside the vehicle cabin through the speakers. The ambient light 25 is installed in the instrument panel and the steering wheel, among other locations. The ambient light 25 provides information by changing its emission color, utilizing the driver's peripheral vision through ambient display.

The operation device 26 is an input unit that accepts user operations from the driver or others. The operation device 26 receives inputs such as user operations related to the activation and deactivation of autonomous driving functions and user operations related to setting the destination for route guidance. Furthermore, user operations for configuring settings related to U-turn control, which will be described later, are also input into the operation device 26. The operation device 26 includes a steering switch provided on the spoke part of the steering wheel, an operation lever provided on the steering column, and a voice input device that recognizes the driver's speech.

The HMI control unit 100 is a computer primarily including a control circuit that includes a processing unit 11, a RAM 12, a storage unit 13, an input/output interface 14, and a bus that connects these components. The HMI control unit 100 functions as a presentation control device. The HMI control unit 100, in coordination with the autonomous driving system 50, presents information related to autonomous driving. The HMI control unit 100, by executing the program (presentation control program) stored in the storage unit 13 through the processing unit 11, includes functional units related to presentation control such as an information coordination unit 82 and a presentation control unit 88 (see FIG. 2).

The information coordination unit 82 collaborates with the autonomous driving ECU 50b and the navigation ECU 38, enabling the sharing of information among the autonomous driving system 50, the navigation ECU 38, and the HMI control unit 100. The information coordination unit 82 provides the operational information of user inputs entered into the operation device 26 to the autonomous driving ECU 50b and the navigation ECU 38, among others. The information coordination unit 82 acquires control status information indicating the control state of the autonomous driving function, as well as notification implementation requests related to the autonomous driving function, from the autonomous driving ECU 50b. The information coordination unit 82 acquires route information indicating the set route to the destination from the navigation ECU 38.

The presentation control unit 88 integratively controls the presentation of information using multiple display devices, the audio device 24, the ambient light 25, and other such components. For example, if the termination of autonomous driving control is planned by the autonomous driving ECU 50b, the presentation control unit 88 will issue a notification requesting the driver to take over driving, based on the implementation request acquired by the information coordination unit 82. Additionally, the presentation control unit 88 issues notifications related to route guidance based on the route information generated by the navigation ECU 38 (see FIGS. 7 and 8, etc.).

Next, a further detailed description of the autonomous driving ECU 50b will be provided.

The autonomous driving ECU 50b is equipped with higher computational power than the driving assistance ECU 50a and is capable of performing driving control equivalent to at least ACC, LTC, and LCA. In addition to the scenarios of driving on general roads mentioned above, the autonomous driving ECU 50b also performs driving assistance control, which requires the driver to monitor the surroundings, in place of the driving assistance ECU 50a during scenarios such as temporarily suspending autonomous driving control.

The autonomous driving ECU 50b is a computer primarily including a control circuit equipped with a processing unit 51, a RAM 52, a storage unit 53, an input/output interface 54, and a bus connecting these components. The processing unit 51 executes various processes (instructions) to implement the autonomous driving control method and the vehicle control method according to the present disclosure by accessing the RAM 52. The storage unit 53 stores various programs (such as the autonomous driving control program and vehicle control program) that are executed by the processing unit 51. By executing the programs through the processing unit 51, the autonomous driving ECU 50b constructs functional units such as an information coordination unit 61, an environment recognition unit 62, an action determination unit 63, and a control execution unit 64 to implement the autonomous driving function (driving control function) and vehicle control function (see FIG. 2).

The information coordination unit 61 implements the provision of information to the HMI control unit 100 and the acquisition of information from the HMI control unit 100 by coordinating information with the information coordination unit 82 of the HMI control unit 100. The information coordination unit 61 includes sub-functional units for coordinating information with the HMI control unit 100, namely, an HMI information acquisition unit 71 and a notification request unit 72.

The HMI information acquisition unit 71 recognizes the content of user operations input via the CID 22 and the operation device 26 by the driver or others, based on the operation information acquired from the HMI control unit 100. The HMI information acquisition unit 71, for example, recognizes operations such as the Level 2 transition operation that instructs the shift from manual driving to driving support control, and the Level 3 transition operation that instructs the shift from driving support control to autonomous driving control. Additionally, the HMI information acquisition unit 71 recognizes driver status information through the HMI control unit 100, including the driver's driving posture, gaze direction, presence or absence of surrounding monitoring, presence or absence of secondary tasks, level of alertness, and presence or absence of any physical condition abnormalities.

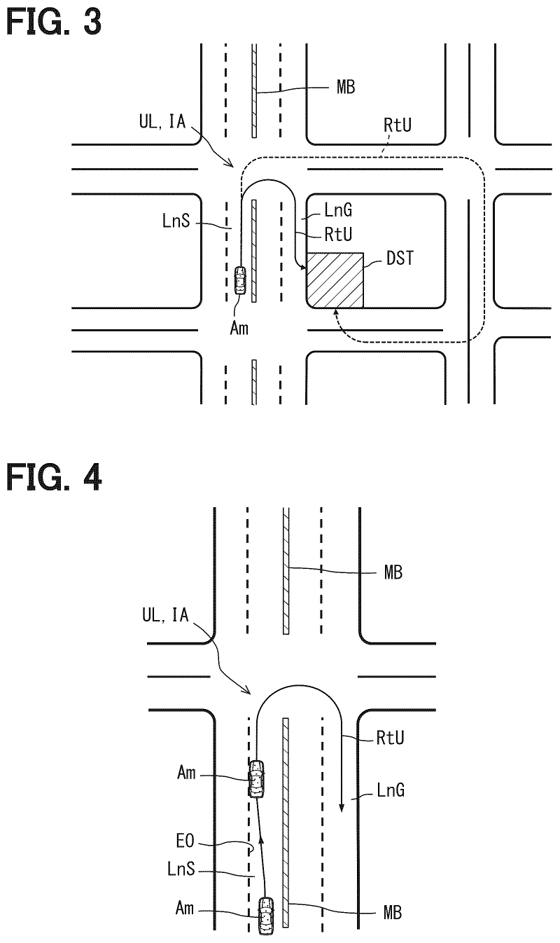

The notification request unit 72 enables notifications by the HMI control unit 100 synchronized with the operational status of the autonomous driving function by outputting a request for the execution of notifications directed to the HMI control unit 100. The notification request unit 72, for example, outputs a request for the execution of a notification to the HMI control unit 100 to request a change of driver when the termination of autonomous driving control is planned. In addition, the notification request unit 72 outputs a request for the execution of notifications related to U-turn control (see FIG. 3, etc.) to the HMI control unit 100.

The environment recognition unit 62 recognizes the driving environment of the host vehicle Am by combining locator information acquired from the locator 35, map data, and detection information acquired from the peripheral monitoring sensor 30 and the in-vehicle communication device 39. The environment recognition unit 62 acquires route information from the navigation ECU 38 and provides the acquired route information to the action determination unit 63.

The environment recognition unit 62 includes a target recognition unit 74 and a road recognition unit 75 as sub-functions for recognizing the driving environment. The target recognition unit 74 identifies the relative position and relative speed of dynamic objects around the host vehicle Am, such as other vehicles traveling in the vicinity. The road recognition unit 75 acquires road information related to the road on which the host vehicle Am is traveling or is planned to travel. The environment recognition unit 62 sequentially provides the action determination unit 63 with the information recognized by the target recognition unit 74 and the road recognition unit 75, i.e., the recognition results of the driving environment.

When the autonomous driving ECU 50b has control authority over the driving operations, the action determination unit 63 determines the actions to be taken by the host vehicle Am based on the recognition results of the driving environment provided by the environment recognition unit 62. The action determination unit 63 includes a route planning unit 77 and a control switching unit 78 as sub-functions responsible for executing control related to the autonomous driving function.

The route planning unit 77 creates a travelling plan (or may be referred to as path plan or driving plan) for guiding the host vehicle Am along the set route indicated by the route information, while referring to the recognition results of the driving environment provided by the environment recognition unit 62. Specifically, the route planning unit 77 generates planned travelling paths for making right or left turns at intersections (see FIG. 3), as well as planned travelling paths for lane changes at merge or diverge points. The generated planned travelling paths are then output to the control execution unit 64. The term “travelling” may also be referred to as a term “driving” in the present disclosure. For example, the travelling plan corresponds to a driving plan, and the travelling path corresponds to a driving path.

The control switching unit 78 coordinates with the driving assistance ECU 50a and the HMI control unit 100 to manage the transition of driving control between the autonomous driving system 50 and the driver. Specifically, the control switching unit 78 switches the driving control state of the host vehicle Am among manual driving (control off), level 2 driving assistance control where the driver has the duty of surrounding monitoring, and level 3 autonomous driving control where the driver does not have the duty of surrounding monitoring. The control switching unit 78 may further switch between level 2 driving assistance controls, specifically between driving assistance control where the driver is required to hold the steering wheel (hereinafter referred to as hands-on level 2) and driving assistance control where the driver is not required to hold the steering wheel (hereinafter referred to as hands-off level 2). The control switching unit 78 monitors the current driving control state in the autonomous driving system 50, indicated by control status information, and provides this information to the information coordination unit 61 and other relevant components. The control status information is provided to the HMI control unit 100 and other relevant components via the information coordination unit 61.

When the autonomous driving ECU 50b has control authority over driving operations, the control execution unit 64, in coordination with the driving control ECU 40, executes acceleration/deceleration control and steering control of the host vehicle Am according to the planned travelling path generated by the action determination unit 63. Specifically, the control execution unit 64 generates control commands based on the planned travelling path and sequentially outputs the generated control commands to the driving control ECU 40.

### (U-Turn Control by Autonomous Driving ECU)

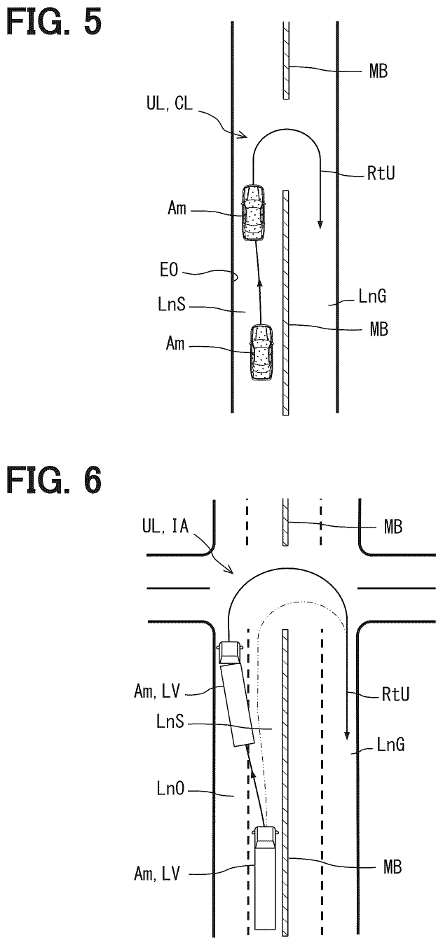

The autonomous driving ECU 50b described thus far performs U-turn control at an intersection IA (see FIG. 3, etc.) or at gaps in a median strip MB (see FIG. 5). The details of the U-turn control executed by the autonomous driving ECU 50b, as well as specific examples of route guidance notifications associated with the U-turn control, will be sequentially described with reference to FIGS. 1 and 2, based on FIGS. 3 to 10.

### (Details of U-Turn Control)

The route planning unit 77 determines whether a U-turn will be effective for approaching the destination DST during the autonomous driving period at level 2 or higher, where the autonomous driving ECU 50b has control over the driving operations. A U-turn is a turning maneuver that changes the traveling direction of the host vehicle Am by approximately 180°, in a manner that traces the shape of the letter “U”. As an example, in the scene shown in FIG. 3, the route for making a U-turn (hereinafter referred to as U-turn route RtU) allows the host vehicle Am to approach the destination DST more easily compared to the usual route when a U-turn is not made (hereinafter referred to as a detour route RtD).

The route planning unit 77 decides to adopt the U-turn route RtU if making a U-turn can eliminate the need for multiple right or left turns and can shorten the travel distance. The route planning unit 77 generates a planned travelling path for making a U-turn based on the decision to adopt the U-turn route RtU. Specifically, the route planning unit 77 defines a U-shaped planned travelling path that moves from the current driving lane (hereinafter referred to as the turn-origin lane LnS) to the opposite lane (hereinafter referred to as the turn-destination lane LnG), where the direction of travel is exactly opposite to that of the current driving lane. The radius of the U-shaped turning section is set to be approximately equal to or slightly larger than the minimum turning radius of the host vehicle Am, based on the vehicle's minimum turning radius. In the present disclosure, the turn-origin lane may also be simply referred to as a current lane, an originating lane, a starting lane, or an initial lane. The turn-destination lane may also be simply referred to as a destination lane or a target lane.

The route planning unit 77 designates the innermost lane of a multi-lane road as the turn-origin lane LnS when the host vehicle Am is traveling on a road with two or more lanes in one direction. On the other hand, the route planning unit 77 principally designates the outermost lane of the multi-lane road as the turn-destination lane LnG. However, if the minimum turning radius of the host vehicle Am is sufficiently small relative to the lane width, the route planning unit 77 may designate an inner lane among the multiple lanes as the turn-destination lane LnG.

The route planning unit 77 generates a planned travelling path that offsets the travel position of the host vehicle Am outward within the turn-origin lane LnS to facilitate a smooth U-turn (see FIGS. 4 and 5). Through offset control based on this planned travelling path, the host vehicle Am is moved towards the outer edge EO, which is located on the side of the turn-origin lane LnS that is farthest from the turn-destination lane LnG. The outer edge EO is either the demarcation line that delineates the turn-origin lane LnS or the road edge of the roadway being traveled.

The route planning unit 77 recognizes the type of location where the U-turn is planned to be performed (hereinafter referred to as the U-turn planned location UL). Specifically, the route planning unit 77 determines whether the U-turn planned location UL is the intersection IA or not. The route planning unit 77 adjusts the shape of the planned travelling path so that the content of the U-turn control changes depending on whether the U-turn planned location UL is the intersection IA or not. The route planning unit 77 generates a planned travelling path that brings the host vehicle Am closer to the outer edge EO when the U-turn planned location UL is the intersection IA (see FIG. 4) compared to when the U-turn planned location UL is not the intersection IA (see FIG. 5). In other words, when the lane width of the turn-origin lane LnS is the same, the offset amount towards the outer side from the center of the turn-origin lane LnS is made larger for a U-turn at the intersection IA compared to a U-turn at a location other than the intersection IA. As a result, when making a U-turn at the intersection IA, the host vehicle Am will be closer to the outer edge EO compared to when making a U-turn at a location other than the intersection IA.

Here, a U-turn planned location UL that is not the intersection IA refers to, for example, a connecting road CL formed at a break in the median strip MB (see FIG. 5). The median strip MB is a structure provided in a strip-like manner between two lanes (lane groups) with opposing directions of travel. The connecting road CL is a travel area that connects the two lanes separated by the median strip MB according to their respective directions.

The action determination unit 63 executes U-turn control of the host vehicle Am based on the planned travelling path for the U-turn generated by the route planning unit 77, ensuring that it does not obstruct other vehicles or pedestrians. When the road on which the host vehicle Am is traveling includes multiple lanes, the action determination unit 63, based on the decision to perform a U-turn by the route planning unit 77, positions the host vehicle Am in the innermost lane in advance. The action determination unit 63 temporarily stops the host vehicle Am and keeps it in a standby state within the turn-origin lane LnS, offset to the outside, if there are other vehicles or pedestrians present on the planned route of the host vehicle Am. When there are no longer any other vehicles or pedestrians, the action determination unit 63 starts the host vehicle Am and resumes driving along the planned travelling path.

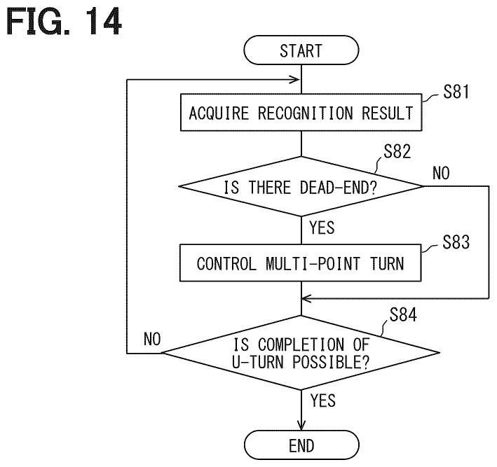

After the initiation of steering control for turning, the action determination unit 63 continuously determines whether a multi-point turn is necessary, in other words, whether the turn can be completed without protruding outside the turn-destination lane LnG, based on the recognition results of the driving environment by the environment recognition unit 62. The action determination unit 63 decides to initiate the multi-point turn control at the point where it is determined that such a turn is necessary, that is, at the point where the host vehicle Am reaches a dead end (see FIG. 14). In the multi-point turn control, the action determination unit 63 moves the host vehicle Am backward by several meters while steering in the direction opposite to the U-turn (see FIG. 10). On roads with narrow lane widths, the multi-point turn control may be performed multiple times. The multi-point turn may also be referred to as a back-and-forth maneuver, a K-turn, a maneuvering correction in the present disclosure.

The HMI information acquisition unit 71 obtains permission from the occupants of the host vehicle Am (for example, the driver) to execute the U-turn control. The driver can pre-set whether to permit the execution of the U-turn control using a settings screen displayed on the CID 22 or similar device. Additionally, the driver can permit the execution of the U-turn control by responding to an inquiry made when the U-turn control is planned to be implemented. The settings regarding the permission for U-turn control can be switched between two stages: “Allowed” and “Not Allowed,” or between three stages: “Allowed,” “Not Allowed,” and “Prohibited.” The term “allowed” may also be referred to as a term “permitted” in the present disclosure.

The action determination unit 63 executes the U-turn control if permission for the execution of U-turn control has been granted by the driver. Specifically, the action determination unit 63 executes the U-turn control that requires multi-point turn only if the execution has been permitted by the driver. On the other hand, even if the execution has not been permitted by the driver, the action determination unit 63 will execute the U-turn control if it does not require the multi-point turn. Furthermore, if the U-turn control is prohibited by the driver, the action determination unit 63 will not execute either the U-turn control that requires the multi-point turn or the U-turn control that does not require the multi-point turn.

Here, as shown in FIG. 6, if the host vehicle Am is a large vehicle such as a large truck LV and requires the multi-point turn at the planned (scheduled) U-turn location UL, the action determination unit 63 decides whether to allow the host vehicle Am to protrude into the outer lane LnO. The outer lane LnO is the lane located on the opposite side of the turn-destination lane LnG, with the turn-origin lane LnS in between. The action determination unit 63 decides to execute the U-turn control that allows the host vehicle Am to protrude into the outer lane LnO, on the condition that there are no other vehicles (parallel vehicles) in the outer lane LnO and no following vehicles in the turn-origin lane LnS (see FIG. 6, U-turn route RtU). By allowing the host vehicle Am to veering to the outer lane LnO, the vehicle can make a wider U-turn than usual (see the two-dot chain line in FIG. 6).

### (Notification of Route Guidance Accompanying U-Turn Control)

When the U-turn control explained so far is performed by the autonomous driving ECU 50b, passengers are likely to feel anxious about the behavior of the host vehicle Am as it significantly changes its direction. To alleviate such anxiety, when the U-turn control is executed by the autonomous driving ECU 50b, information related to the U-turn control is presented to the passengers. Information related to the U-turn control is communicated to the passengers through changes in the host vehicle status StA (see FIG. 7) displayed on the meter display 21 or the CID 22.

The host vehicle status StA notifies passengers of the status of the host vehicle Am and the surrounding conditions. The host vehicle status StA is a bird's-eye view content that depicts the host vehicle Am from an overhead perspective. The host vehicle status StA reproduces the traffic environment surrounding the host vehicle on the display. The HMI control unit 100 uses detection information from the peripheral monitoring sensor 30 and the like to render the host vehicle status StA. The HMI control unit 100 may acquire the recognition results of the driving environment from the environment recognition unit 62 and use the acquired recognition results to render the host vehicle status StA.

The host vehicle status StA includes a road background RB, a host vehicle icon IcS, another vehicle icon IcB, and a planned trajectory icon IPP. The road background RB is an image that reproduces the shape of the road surrounding the host vehicle on the display. The host vehicle icon IcS is an image component that models the host vehicle. The host vehicle icon IcS is displayed approximately at the center of the host vehicle status StA.

The other vehicle icon IcB is an image component that is displayed based on detection information or recognition results, indicating the presence of actual other vehicles traveling around the host vehicle. The other vehicle icon IcB is superimposed on the road background RB in a position that reflects the relative location of the other vehicle. When there are no other vehicles around the host vehicle, the other vehicle icon IcB is not displayed.

The planned trajectory icon IPP is an image component that extends linearly or in a band-like manner from the starting point of the host vehicle icon IcS. The planned trajectory icon IPP is drawn based on the information of the planned travelling path generated by the route planning unit 77, reproducing the intended travel path of the host vehicle Am upon the host vehicle status StA.

The host vehicle status StA, through the display of the planned trajectory icon IPP, has the function of guiding the occupants along the planned travel path assigned to the host vehicle Am. For example, when a U-turn is being performed, the host vehicle status StA provides U-turn route guidance by displaying the planned trajectory icon IPP, which is curved in a U-shape (see FIG. 7). Additionally, when making a right turn, the host vehicle status StA provides right turn route guidance by displaying the planned trajectory icon IPP, which bends to the right (see FIG. 8).

The host vehicle status StA performs U-turn route guidance in a different manner when U-turn control is planned to be executed according to the travel plan, compared to when U-turn control is not planned to be executed. Specifically, when U-turn control is planned to be executed, the virtual viewpoint position in the host vehicle status StA and the rendering mode of the planned trajectory icon IPP are altered.

When U-turn control is planned to be executed, the virtual viewpoint position (see FIG. 7) is set higher and farther from the host vehicle icon IcS (host vehicle Am) compared to the virtual viewpoint position when making a right turn or taking the detour route RtD (see FIG. 8). As a result, a wide range of the surrounding conditions around the host vehicle is displayed in the host vehicle status StA.

Additionally, when U-turn control is planned to be executed, the planned trajectory icon IPP (see FIG. 7) is emphasized more than the usual planned trajectory icon IPP used during normal right turns or similar maneuvers (see FIG. 8). Specifically, the planned trajectory icon IPP indicating a planned U-turn is rendered as a band shape and displayed thicker compared to the linearly drawn planned trajectory icon IPP used during normal conditions. The planned trajectory icon IPP indicating a planned U-turn may also be made more conspicuous compared to normal conditions by increasing the display brightness or changing the display color. As a result, the U-turn route guidance, when U-turn control is planned to be executed, is presented in a more emphasized manner compared to right-turn route guidance or other guidance when U-turn control is not planned.

Furthermore, when U-turn control is executed, a monitoring recommendation icon IcM is additionally displayed on the meter display 21 or the CID 22. The monitoring recommendation icon IcM is an image component that provides a notification prompting the driver to monitor the surroundings. The monitoring recommendation icon IcM is displayed along with the host vehicle status StA, even when the autonomous driving ECU 50b is executing autonomous driving control that does not require surrounding monitoring obligations.

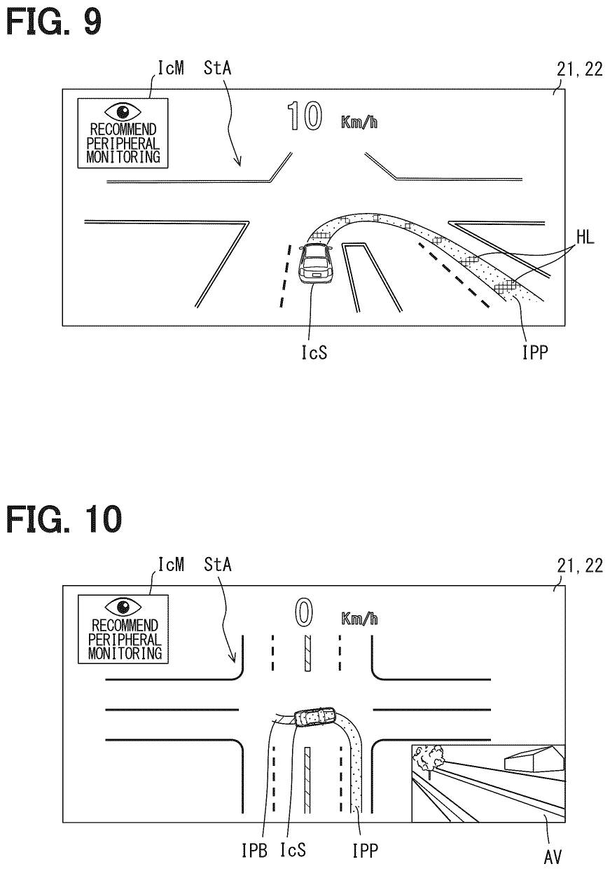

Furthermore, the mode of the U-turn route guidance based on the host vehicle status StA changes depending on whether the U-turn control involves a temporary stop of the host vehicle Am (see FIG. 7) or does not involve a temporary stop of the host vehicle Am (see FIG. 9). As an example, when a temporary stop is not performed during U-turn control, multiple emphasis sections HL are superimposed at intervals on the planned trajectory icon IPP. The emphasis sections HL repeatedly flow along the planned trajectory icon IPP in the direction of travel of the host vehicle Am. With such a change in the mode of the planned trajectory icon IPP, the U-turn route guidance is emphasized more when a temporary stop is not performed during U-turn control compared to when a temporary stop is performed.

Additionally, the mode of the U-turn route guidance based on the host vehicle status StA changes depending on whether the host vehicle Am performs a multi-point turn during U-turn control (see FIG. 10) or does not perform a multi-point turn during U-turn control (see FIG. 7). As an example, when a multi-point turn is performed during U-turn control, a wider range of the surrounding situation of the vehicle is displayed in the host vehicle status StA compared to when a multi-point turn is not performed.

Specifically, when a multi-point turn is performed, the virtual viewpoint position of the host vehicle status StA is set directly above the host vehicle icon IcS (the host vehicle Am). Additionally, the virtual viewpoint position is set at a position further away from the host vehicle icon IcS. As a result, the host vehicle status StA provides an around-view display. In the host vehicle status StA, the reverse trajectory icon IPB indicating the movement trajectory of the reversing vehicle Am may be displayed in a different manner than the planned trajectory icon IPP indicating the movement trajectory of the U-turn. Furthermore, at least one peripheral camera image AV is additionally displayed on the meter display 21 or the CID 22. The peripheral camera image AV is a real-time image captured by the camera unit and informs the occupants of the situation in the direction of travel of the host vehicle Am.

### (Details of Each Process Related to U-Turn Control)

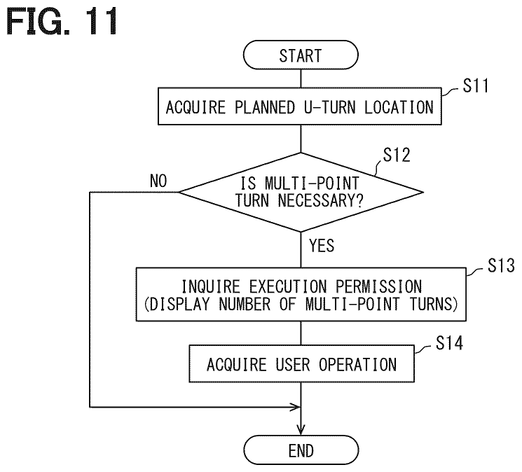

Next, in order to realize the U-turn control and U-turn route guidance explained thus far, details of each process executed by the autonomous driving ECU 50b and the HMI control unit 100 will be explained with reference to FIGS. 1 to 10, based on FIGS. 11 to 14.

### (U-Turn Execution Inquiry Process)

The inquiry process shown in FIG. 11 is a process that inquires with the occupant (such as the driver) whether to permit the execution of U-turn control. The inquiry process is initiated when the vehicle approaches a predetermined distance (for example, about 1 km) from the planned U-turn location UL. The inquiry process is carried out through the collaboration between the autonomous driving ECU 50b and the HMI control unit 100. The planned U-turn location may also be called as a scheduled U-turn location.

In S11 of the inquiry process, the road recognition unit 75 obtains information about the planned U-turn location UL. The road recognition unit 75 primarily obtains information regarding the width of the planned U-turn location UL. In S12, based on the information about the planned U-turn location UL obtained in S11, the action determination unit 63 determines whether a multi-point turn is necessary at the planned U-turn location UL. As an example, if the distance between the centers of the turn-origin lane LnS and the turn-destination lane LnG is shorter than the minimum turning radius of the host vehicle Am, the action determination unit 63 will determine that the vehicle cannot complete the turn in one go and that a multi-point turn is necessary.

If it is determined that a multi-point turn is not necessary at the planned U-turn location UL (S12: NO), the inquiry process is terminated. On the other hand, if it is determined that a multi-point turn is necessary at the planned U-turn location UL (S12: YES), then in S13, the notification request unit 72, in coordination with the HMI control unit 100, inquires with the occupant whether to permit the execution of the U-turn control. As an example, “Do you permit a U-turn ahead?” a message such as “Do you permit a U-turn ahead?” is displayed on the CID 22, HUD 23, or similar device. At this time, selection icons such as “Permit” and “Do not execute” may be displayed on the CID 22 or the HUD 23.

In the inquiry at S13, the number of multi-point turns required for the U-turn control is presented to the occupant. The number of multi-point turns serves as information for determining whether to permit the execution of the U-turn control. For example, “Due to the narrow road width, at least one multi-point turn is expected,” or “Multiple multi-point turns are expected.” Messages such as these are displayed on the CID 22 or HUD 23.

In response to the inquiry conducted at S13, the occupant, such as the driver, inputs a user operation to instruct the permission or cancellation of the U-turn control. In S14, the HMI information acquisition unit 71 collaborates with the HMI control unit 100 to acquire the operation information of the user operation input by the occupant. As a result, the feasibility of executing the U-turn control that requires a multi-point turn is set.

The determination in S12 in the inquiry process may be omitted. That is, an inquiry regarding the feasibility of executing the U-turn control may be conducted even if a multi-point turn is not required at the planned U-turn location UL. In this case, information indicating the presence or absence of a planned multi-point turn, instead of or in addition to the number of multi-point turns, is presented to the occupant as information for determining whether to permit the execution of the U-turn.

### (Driving Plan Generation Process)

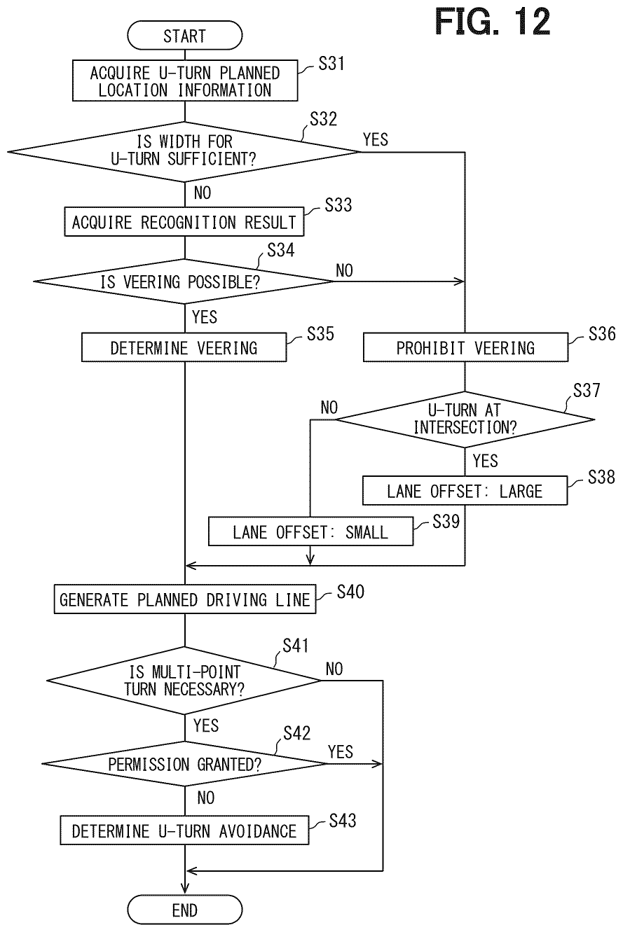

The travelling plan generation process shown in FIG. 12 is a process for generating a travelling plan (planned travelling path) to perform U-turn control. The travelling plan generation process is initiated by the autonomous driving ECU 50b when the vehicle approaches the planned U-turn location UL within a predetermined distance (for example, several hundred meters).

In S31 of the travelling plan generation process, similar to the inquiry process of S11 (see FIG. 11), the road recognition unit 75 acquires information about the planned U-turn location UL. In S32, based on the information acquired in S31, the action determination unit 63 determines whether the planned U-turn location UL has sufficient space to perform a U-turn without needing to reverse.

If the planned U-turn location UL is determined to be narrow and requires a multi-point turn (S32: NO), the action determination unit 63 acquires the recognition results of the driving environment from the environment recognition unit 62 in S33. Based on the acquired recognition results, the action determination unit 63 determines in S34 whether it is possible to veer to the outer lane LnO. If it is determined that encroaching into the outer lane LnO is possible (S34: YES), the action determination unit 63 decides in S35 to allow the host vehicle Am to encroach into the outer lane LnO. In this case, the route planning unit 77 generates a planned travelling path in S40 that allows the host vehicle Am to veer from the turn-origin lane LnS into the outer lane LnO (see FIG. 6).

On the other hand, if the planned U-turn location UL is determined to be wide and does not require a multi-point turn (S32: YES), or if it is determined that veering into the outer lane LnO is not possible (S34: NO), the action determination unit 63 prohibits veering into the outer lane LnO in S36.

In S37, the route planning unit 77 determines whether the planned U-turn location UL is the intersection IA. If the planned U-turn location UL is determined to be the intersection IA (S37: YES), the route planning unit 77 sets the offset amount of the host vehicle Am within the turn-origin lane LnS to “large” in S38. Based on this setting, the route planning unit 77 generates a planned travelling path in S40 that brings the host vehicle Am closer to the outer edge EO (see FIG. 4).

On the other hand, if the planned U-turn location UL is a connecting road CL or the like other than the intersection IA (S37: NO), the route planning unit 77 sets the offset amount of the host vehicle Am within the turn-origin lane LnS to “small” in S39. Based on this setting, the route planning unit 77 generates a planned travelling path in S40 that brings the host vehicle Am slightly closer to the outer edge EO (see FIG. 5). As described above, the content of the U-turn control is modified depending on whether the planned U-turn location UL is the intersection IA or not.

In S41, the action determination unit 63 refers to the planned travelling path generated in S40 and determines once again whether a multi-point turn is necessary. If a multi-point turn is not necessary (S41: NO), the travel plan generation process is terminated. In this case, based on the planned travelling path generated in S40, it is decided to execute the U-turn control to drive along the U-turn route RtU.

On the other hand, if a multi-point turn is necessary (S41: YES), the action determination unit 63 determines in S42 whether permission to execute the U-turn control has been obtained from the occupant. If the execution of the U-turn control is permitted based on user operation in response to the inquiry (see FIG. 11, S14) or prior settings (S42: YES), the travel plan generation process is terminated. In this case as well, based on the planned travelling path generated in S40, it is decided to execute the U-turn control to drive along the U-turn route RtU. As described above, only U-turn control that involves a multi-point turn requires the occupant's permission.

On the other hand, if the execution of the U-turn control is not permitted (S42: NO), the action determination unit 63 decides to avoid executing the U-turn in S43. In this case, the route planning unit 77 decides to adopt the detour route RtD (see FIG. 3). The route planning unit 77 discards the planned travelling path generated in S40 and newly generates a planned travelling path for making a right or left turn.

### (U-Turn Notification Process)

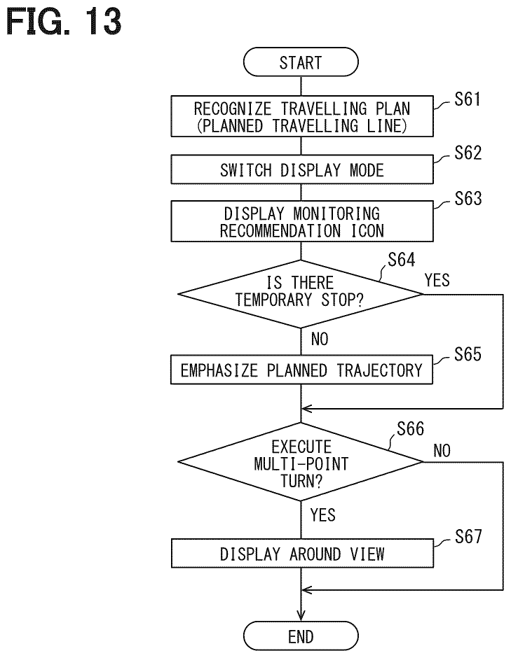

The U-turn notification process shown in FIG. 13 is a process that switches the host vehicle status StA (see FIG. 7) in a manner that notifies the planned execution of the U-turn control (U-turn route guidance). The U-turn notification process is initiated based on the confirmation of the adoption of the planned travelling path for executing the U-turn in the travel plan generation process (see FIG. 12). The U-turn notification process is carried out through the coordination between the autonomous driving ECU 50b and the HMI control unit 100.

In S61 of the U-turn notification process, the route planning unit 77 recognizes the travel plan (planned travelling path) of the host vehicle Am used by the autonomous driving ECU 50b (driving control function). In S62, the notification request unit 72, in coordination with the HMI control unit 100, switches the mode of the host vehicle status StA. In S62, the virtual viewpoint position of the host vehicle status StA and the drawing mode of the planned trajectory icon IPP are changed (see FIG. 7). As a result, when U-turn control is planned to be implemented, the route guidance notification (U-turn route guidance) is carried out in a manner that is different from when U-turn control is not planned and is emphasized.

In S63, a monitoring recommendation icon IcM (see FIG. 7) is additionally displayed on the screen of the display device showing the host vehicle status StA. As a result, the driver is prompted to carry out surrounding monitoring (surrounding confirmation).

In S64, the action determination unit 63 determines whether to temporarily stop the host vehicle Am. If there are no other vehicles or pedestrians on the planned route and a U-turn can be initiated without stopping temporarily (S64: NO), in S65, the planned trajectory icon IPP is highlighted by the additional display of the emphasis section HL (see FIG. 9). On the other hand, if a temporary stop is performed before initiating the U-turn (S64: YES), S65 is skipped, and the additional display of the emphasis section HL is omitted. As a result, the mode of route guidance notification is altered depending on whether a temporary stop is performed during U-turn control or not.

In S66, the action determination unit 63 determines whether to execute a multi-point turn. If a multi-point turn of the host vehicle Am is to be performed (S66: YES), in S67, the host vehicle status StA is switched to an around-view display by moving the virtual viewpoint position (see FIG. 10). Additionally, in S67, additional display of the peripheral camera image AV is performed. On the other hand, if a multi-point turn is not performed (S66: NO), S67 is skipped, and neither the change in virtual viewpoint position nor the additional display of the peripheral camera image AV is executed. As a result, when a multi-point turn is performed during U-turn control, a wider range of the surroundings of the vehicle is notified through route guidance by the host vehicle status StA, compared to when a multi-point turn is not performed.

### (Multi-Point Turn Execution Process)

The multi-point turn execution process shown in FIG. 14 is carried out by the autonomous driving ECU 50b based on the initiation of U-turn control. In S81 of the multi-point turn execution process, the action determination unit 63 acquires the recognition results of the driving environment from the environment recognition unit 62. Then, in S82, the action determination unit 63 determines whether the host vehicle Am has become stuck after the initiation of U-turn control. If it is determined that the host vehicle Am can no longer complete the turn and is stuck (S82: YES), the action determination unit 63 initiates multi-point turn control in S83. On the other hand, if it is determined that the host vehicle Am can complete the turn and is not stuck (S82: NO), the multi-point turn control in S83 is not initiated.

The action determination unit 63 determines in S84 whether the U-turn can be successfully completed. If it is determined that the host vehicle Am is in a state where it can complete the turn and the U-turn can be successfully finished (S84: YES), the multi-point turn execution process is terminated. On the other hand, if a further multi-point turn is necessary (S84: NO), the process from S81 to S84 is repeated. As a result, several times of multi-point turn may also be executed.

### Summary of First Embodiment

In the first embodiment described so far, if the travel plan used by the travel control function schedules the execution of U-turn control, the route guidance notification will differ from when the execution of U-turn control is not planned. Therefore, the occupant of the host vehicle Am can be informed about the planned execution of U-turn control through route guidance notifications that differ from the usual ones. As a result, it becomes possible to alleviate the occupants' anxiety when U-turn control is being executed.

Additionally, in the first embodiment, the route guidance notification for when U-turn control is planned to be executed is provided in a more emphasized manner compared to the route guidance notification for when U-turn control is not planned. In other words, the U-turn control is executed while the emphasized route guidance notification is being provided, as indicated by the host vehicle status StA (see FIG. 7). According to the above, the occupants can reliably recognize the emphasized route guidance notification and can be informed in advance about the execution of U-turn control. As a result, the occupants' anxiety regarding the U-turn control can be further alleviated.

In the first embodiment, it is determined whether the planned U-turn location UL, where U-turn control is planned to be executed, is the intersection IA or not. The details of the U-turn control are then modified based on whether the planned U-turn location UL is the intersection IA or not. As described above, by modifying the control for the U-turn at the intersection IA and the U-turn at a location other than the intersection IA, the action determination unit 63 can achieve appropriate driving of the host vehicle Am for each scenario. As a result, it becomes possible to alleviate the occupants' anxiety when U-turn control is executed.

Furthermore, in the first embodiment, when U-turn control from the turn-origin lane LnS to the turn-destination lane LnG is executed, the host vehicle Am is maneuvered towards the outer edge EO, which is located on the side of the turn-origin lane LnS farthest from the turn-destination lane LnG. According to such offset control, a smooth U-turn can be more easily executed even on roads that are not wide.

Additionally, in the first embodiment, if the planned U-turn location UL is at the intersection IA, the host vehicle Am is brought closer to the outer edge EO compared to when the planned U-turn location UL is not at the intersection IA. According to the above, during a U-turn at the intersection IA, where environmental changes around the vehicle are significant, the action determination unit 63 can control the host vehicle Am to complete the turn in one go without the need for a multi-point turn. By reducing the need for such a multi-point turn, it becomes possible to alleviate the anxiety of passengers caused by U-turn control.

In the first embodiment, the mode of route guidance notification is changed depending on whether the host vehicle Am comes to a temporary stop during U-turn control. According to the above, appropriate route guidance notifications can be provided based on whether a temporary stop occurs during U-turn control. As a result, it becomes possible to alleviate the anxiety of passengers when U-turn control is performed.

Furthermore, in the first embodiment, route guidance notifications are emphasized more in cases where no temporary stop is made during U-turn control compared to cases where a temporary stop is made (see FIG. 9). In this way, by informing the passengers in advance through emphasized route guidance that a temporary stop will be omitted, it becomes possible to alleviate the passengers' anxiety even during the U-turn where no temporary stop is made.

Additionally, in the first embodiment, the manner of route guidance notification is altered depending on whether the host vehicle Am performs a multi-point turn during U-turn control. According to the above, passengers can anticipate whether a multi-point turn will be performed based on the route guidance notifications. As a result, even when performing the U-turn that involve a multi-point turn, it becomes possible to alleviate the passengers' anxiety.

Additionally, in the first embodiment, when a multi-point turn is performed during U-turn control, a broader range of surrounding conditions around the vehicle is communicated through the route guidance compared to when no multi-point turn is performed. According to the above, passengers will find it easier to understand the surrounding conditions of the vehicle in scenarios where a multi-point turn occurs. As a result, it becomes possible to alleviate the passengers' anxiety during the multi-point turn.

Furthermore, in the first embodiment, the deadlock of the host vehicle Am is determined after the initiation of the U-turn control. Then, the multi-point turn is initiated from the point where the deadlock is determined. In this way, if the turning control is initiated early from the point of deadlock, in other words, the point where it becomes clear that the turn cannot be completed, a smooth U-turn can be executed even on roads with insufficient width. As a result, it becomes possible to alleviate the passengers' anxiety when U-turn control is performed.

Additionally, in the first embodiment, permission to execute the U-turn control is obtained from the passengers of the host vehicle Am. Then, U-turn control is executed when permission to perform the U-turn control is granted by the passengers. In this way, requiring the passengers' permission for U-turn control can prevent the forced execution of U-turns in situations where passengers are likely to feel anxious. As a result, it becomes possible to alleviate the passengers' anxiety caused by the U-turn.

In the first embodiment, the number of multi-point turns required for the U-turn control is communicated to the passengers as information to help them decide whether to permit the execution of the U-turn control. Accordingly, passengers can make an informed decision on whether to proceed with the planned U-turn. As a result, the execution of U-turns in situations where passengers are likely to feel anxious can be progressively avoided.

Furthermore, in the first embodiment, U-turn control that requires the multi-point turn is implemented only when permission is granted by the passengers. On the other hand, if the U-turn control does not require the multi-point turn, it will be executed even without the passengers' permission. As described above, by requiring passengers' permission only for U-turns that involve the multi-point turn, it is possible to avoid executing U-turns in situations where passengers are likely to feel anxious, while also achieving the benefit of improved convenience from executing U-turns when necessary.

Additionally, in the first embodiment, when U-turn control is implemented, a notification prompting the driver to monitor the surroundings is issued. Specifically, the driver is prompted to check the surroundings of the vehicle through the display of a monitoring recommendation icon IcM. In this way, by prompting the driver to check the surroundings during the execution of a U-turn and directing the passengers' attention to the driving process, it is possible to further alleviate any anxiety the passengers may have due to the U-turn control.

Additionally, in the first embodiment, when executing U-turn control from the turn-origin lane LnS to the turn-destination lane LnG, it is determined whether the host vehicle Am will veer into the outer lane LnO, which is located on the opposite side of the turn-destination lane LnG across from the turn-origin lane LnS. In this manner, if protrusion into the outer lane LnO is permitted, even if the planned U-turn location UL does not have sufficient width for a U-turn, it is possible to suppress the need for the multi-point turn and implement smooth U-turn control.

In the above first embodiment, the autonomous driving ECU 50b corresponds to the “vehicle controller,” the action determination unit 63 corresponds to the “control execution unit,” and the HMI information acquisition unit 71 corresponds to the “permission acquisition unit.” Furthermore, the notification request unit 72 corresponds to the “notification execution unit,” and the route planning unit 77 corresponds to the “plan recognition unit.”

### Second Embodiment

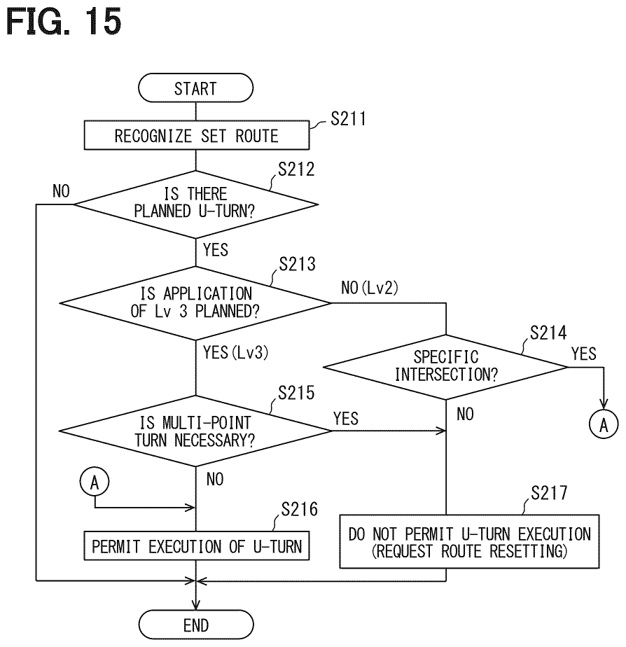

A second embodiment of the present disclosure is a modification of the first embodiment. In the second embodiment, the autonomous driving ECU 50b can further perform permission determination processing and U-turn proposal processing as part of the processing related to U-turn control. In addition, the autonomous driving ECU 50b executes a different travel plan generation process from that of the first embodiment. Hereinafter, the details of the permission determination processing, U-turn proposal processing, and travel plan generation processing in the second embodiment will be described with reference to FIGS. 15 to 17, while also referring to FIGS. 1 and 2.

### (Permission Determination Processing for U-Turn Control)

The permission determination processing shown in FIG. 15 is a process that determines whether to permit the execution of U-turn control. In the permission determination processing, the criteria for determining whether to permit the execution of U-turn control are modified according to the level of autonomous driving that is planned to be applied to the U-turn control. The action determination unit 63 is designed to more easily permit the execution of U-turn control as the level of autonomous driving increases. That is, the criteria applied to autonomous driving level 3 are more relaxed than the criteria applied to autonomous driving level 2. The permission determination processing is initiated, for example, based on the provision of route information from the navigation ECU 38 to the environment recognition unit 62.

In S211 of the permission determination processing, the route planning unit 77 recognizes the set route indicated by the route information acquired by the environment recognition unit 62. In S212, the route planning unit 77 determines whether there is a planned U-turn location UL on the set route. If there is no planned U-turn location UL (S212: NO), the permission determination processing is terminated.

On the other hand, if there is a planned U-turn location UL (S212: YES), the route planning unit 77 determines the level of autonomous driving that is planned to be applied for the U-turn control at the planned U-turn location UL in S213. In S213, it is determined whether the planned U-turn location UL is within an authorized area where the implementation of Level 3 autonomous driving (autonomous driving control) is permitted. If the planned U-turn location UL is outside the authorized area and U-turn control is planned to be implemented at autonomous driving Level 2 (S213: NO), the criteria for permitting the implementation of U-turn control will be stricter than when U-turn control is planned to be implemented at autonomous driving Level 3.

The route planning unit 77 determines the type of the planned U-turn location UL in S214. Specifically, the route planning unit 77 determines whether the planned U-turn location UL is a large-scale intersection (IA) where traffic signals are installed and dedicated turning lanes are included (see FIG. 3, etc., hereinafter referred to as a “specific intersection”). If the planned U-turn location UL is a specific intersection (S214: YES), the action determination unit 63 permits the implementation of U-turn control at the planned U-turn location UL in S216. On the other hand, if the planned U-turn location UL is not a specific intersection but a small-scale intersection (IA) or a connecting road CL (see FIG. 3, etc.) (S214: NO), the action determination unit 63 will not permit the implementation of U-turn control in S217. In this case, the action determination unit 63 requests the navigation ECU 38 to reset the route to one that does not involve a U-turn.

The action determination unit 63 modifies the planned travelling path of the host vehicle Am during U-turn control according to the level of autonomous driving intended to be applied for the U-turn control. The action determination unit 63 sets the planned travelling path such that the higher the level of autonomous driving, the less need there is for the multi-point turn. Therefore, if the planned U-turn location UL is within the permitted area and U-turn control at autonomous driving level 3 is planned to be implemented (S213: YES), the route planning unit 77 determines in S215 whether the multi-point turn will be necessary for U-turn control at the planned U-turn location UL. If the multi-point turn is necessary for U-turn control (S215: YES), the action determination unit 63 does not permit the implementation of U-turn control in S217. Even in this case, a request is made to the navigation ECU 38 to change the route to one that does not involve making a U-turn. On the other hand, if the multi-point turn is not necessary for U-turn control (S215: NO), the action determination unit 63 permits the implementation of U-turn control at the planned U-turn location UL in S216.

If the set route identified in S211 includes multiple planned U-turn locations UL, the action determination unit 63 determines whether to permit the implementation of U-turn control for each planned U-turn location UL. If the action determination unit 63 does not permit the implementation of U-turn control at any one of the planned U-turn locations UL, it requests the navigation ECU 38 to reset the route beyond the prohibited planned U-turn location UL.

### (Inquiry Processing After Rerouting)

The inquiry processing shown in FIG. 15 is a process in which, after rerouting, it inquires of the driver or other occupants whether to permit the implementation of U-turn control within a specified area of the rerouted path. As an example, the inquiry processing is initiated based on a notification indicating the occurrence of a reroute or the provision of rerouted path information from the navigation ECU 38 to the environment recognition unit 62.

Here, rerouting refers to the process by which the navigation ECU 38 changes the set route of the host vehicle Am. For example, rerouting occurs when the occupant changes the destination, or when an accident or traffic congestion occurs on the planned route, necessitating a change in the intended route. Additionally, if the host vehicle Am is a BEV (Battery Electric Vehicle), rerouting may be carried out due to a decrease in battery charge. As described above, rerouting may be appropriately carried out based on the judgment of the occupant, the navigation ECU 38, and the autonomous driving ECU 50b.

In S221 of the inquiry process, the route planning unit 77 recognizes the rerouted set route indicated by the route information obtained by the environment recognition unit 62. In S222, the route planning unit 77 determines whether there is a planned U-turn location UL within a predetermined area. The predetermined area is, for example, within a range of approximately 1 km to several kilometers from the current position. The size of the predetermined area may be appropriately adjusted according to the driving environment around the vehicle. As an example, the higher the driving speed of the host vehicle Am, the wider the predetermined area may be set in such a driving environment. If there is no planned U-turn location UL within the predetermined area (S222: NO), the inquiry process is terminated.

On the other hand, if there is a planned U-turn location UL within the predetermined area (S222: YES), the route planning unit 77 determines in S223 whether the planned U-turn location UL within the predetermined area satisfies the recommended conditions for U-turn control, thereby qualifying as a recommended U-turn location. The route planning unit 77 determines that the recommended conditions for U-turn control are met when the reduction in the time required to reach the destination DST (see FIG. 3) is significant. Specifically, the route planning unit 77 determines that the recommended conditions are met if the U-turn results in the arrival time at the destination DST being advanced by a predetermined time (for example, several minutes) or more. Additionally, the route planning unit 77 determines that the recommended conditions for U-turn control are met if the planned U-turn location UL is in a road environment that facilitates the execution of a U-turn. Specifically, if the planned U-turn location UL is at the aforementioned specific intersection, the route planning unit 77 determines that the recommended conditions for U-turn control are met. Alternatively, if the U-turn at the planned U-turn location UL does not require a multi-point turn, the route planning unit 77 determines that the recommended conditions for U-turn control are met.

The criteria for determining recommended U-turn locations may be modified as appropriate. For example, the route planning unit 77 may determine a recommended U-turn location that meets the recommended conditions for U-turn control when multiple conditions, such as the aforementioned time conditions and road conditions, are all satisfied.

If the planned U-turn location UL is determined to be a recommended U-turn location (S223: YES), then at S224, a notification is made to allow the driver to choose whether to permit the U-turn immediately after rerouting. In this case, the notification request unit 72 collaborates with the HMI control unit 100 to inquire of the occupant whether to permit the execution of the U-turn control. In this inquiry, the benefits of performing the U-turn are presented to the occupant, and the execution of the U-turn is actively suggested to the occupant.

As an example, messages such as “Making a U-turn ahead will shorten the arrival time” or “There is an intersection suitable for a U-turn ahead” are presented, followed by the query, “Do you permit a U-turn ahead?” are displayed on the CID 22 or HUD 23 along with such messages. In this case as well, selection icons such as “Permit” and “Do not execute” are displayed on the CID 22 or HUD 23.

On the other hand, if the planned U-turn location UL does not meet the recommended conditions and is determined not to be a recommended U-turn location (S223: NO), the action determination unit 63, in S225, will not permit the execution of the U-turn control. In this case, the action determination unit 63 requests the navigation ECU 38 to recalculate the route without executing a U-turn.

Here, the inquiry regarding whether to permit the execution of the U-turn control may be conducted when the planned U-turn location UL does not meet the recommended conditions (S223: NO). In other words, the notification to let the driver decide whether to permit a U-turn immediately after rerouting may be given when the planned U-turn location UL, which does not meet the recommended conditions, is immediately after the reroute. In such a configuration, if the planned U-turn location UL meets the recommended conditions (S223: YES), the action determination unit 63 will automatically permit the execution of the U-turn without relying on the occupant's selection.

Furthermore, if the planned U-turn location UL does not meet the recommended conditions (S223: NO), a standard inquiry may be conducted. In a standard inquiry, the benefits of executing the U-turn are not presented to the occupant, and the question “Do you permit a U-turn ahead?” is asked. A message such as “Do you permit a U-turn ahead?” is displayed. If the occupant does not permit the execution of the U-turn control in response to such an inquiry, the action determination unit 63 will decide not to execute the U-turn control.

### (Travelling Plan Generation Process)

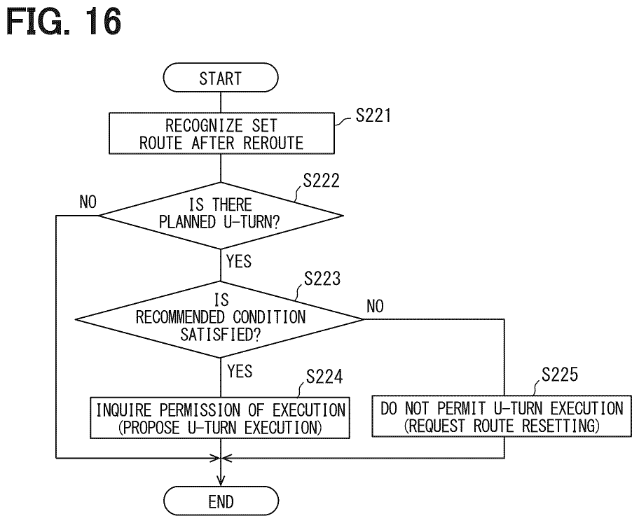

The travelling plan generation process shown in FIG. 16, similar to the first embodiment, is a process for generating a travelling plan to execute U-turn control. It begins when the vehicle approaches the U-turn planned location UL within a predetermined distance (for example, several hundred meters). In the travelling plan generation process, the planned travelling path of the host vehicle Am during U-turn control is modified according to the presence or absence of a following vehicle. Additionally, in the travelling plan generation process, the autonomous driving level during U-turn control is adjusted according to the autonomous driving level permitted on the turn-destination lane LnG (see FIG. 3).

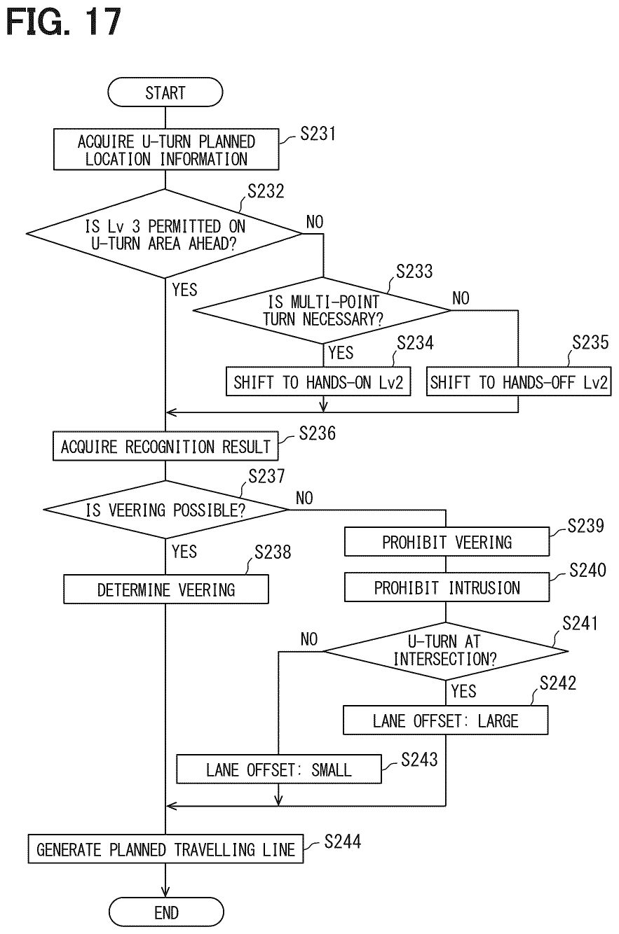

In S231 of the travelling plan generation process in FIG. 17, the road recognition unit 75 acquires information about the U-turn planned location UL. Furthermore, based on the information about the U-turn planned location UL acquired in S231, the road recognition unit 75 determines in S232 whether autonomous driving at level 3 is permitted on the turn-destination lane LnG. If the use of autonomous driving level 3 is permitted on the turn-destination lane LnG (S232: YES), the U-turn control is carried out while maintaining the level 3 autonomous driving control state.

On the other hand, if the use of autonomous driving level 3 is not permitted on the turn-destination lane LnG (S232: NO), the control switching unit 78 changes the autonomous driving level of the ongoing driving control. In this case, while traveling in the turn-origin lane LnS (see FIG. 3), the control switching unit 78 lowers the autonomous driving level to level 2, which is permitted in the turn-destination lane LnG. Additionally, the control switching unit 78 changes the requirement for the driver to hold the steering wheel according to the control load of the U-turn control.

Specifically, in S233, the route planning unit 77 determines whether a multi-point turn will be necessary for the U-turn control at the planned U-turn location UL. If a multi-point turn is necessary for the U-turn control (S233: YES), the control switching unit 78 decides to transition control to hands-on level 2 in S234. On the other hand, if a multi-point turn is not necessary for the U-turn control (S233: NO), the control switching unit 78 decides to transition control to hands-off level 2 in S235. The control switching unit 78, before the U-turn control is initiated, collaborates with the notification request unit 72 to issue a driver takeover request, completing the control transition from autonomous driving level 3 to either hands-on level 2 or hands-off level 2.

In S236, the recognition results of the driving environment around the vehicle are obtained by the environment recognition unit 62. The target recognition unit 74 identifies the rear vehicle traveling behind the host vehicle Am in S236. The target recognition unit 74 may be capable of identifying not only the rear vehicle traveling in the same lane as the host vehicle Am, but also the rear vehicles and parallel vehicles traveling in the adjacent lanes.

Based on the recognition results obtained by the environment recognition unit 62 in S236, the action determination unit 63 determines in S237 whether it is possible to veer into the outer lane LnO. If it is determined that veering to the outer lane LnO is possible (S237: YES), the action determination unit 63 decides to deviate the host vehicle Am into the outer lane LnO in S238. In this case, the route planning unit 77 generates a planned travelling path to cause the host vehicle Am veering from the turn-origin lane LnS to the outer lane LnO in S244 (see FIG. 6).

On the other hand, if a parallel vehicle is present in the outer lane LnO, or if a rear vehicle is present in at least one of the outer lane LnO or the host vehicle's lane, the action determination unit 63 determines that veering into the outer lane LnO is not possible (S237: NO). In this case, the action determination unit 63 prohibits the host vehicle Am from veering into the outer lane LnO in S239. Additionally, the action determination unit 63 also prohibits the intrusion of the host vehicle Am into the outer lane LnO during a multi-point turn in S240. Specifically, during a multi-point turn, the host vehicle Am temporarily reverses at a U-turn planned location UL, such as the intersection IA or the connecting road CL. When expansion during a multi-point turn is prohibited, the action determination unit 63 restricts the movement range of the host vehicle Am to ensure that the rear end of the host vehicle Am does not veer into the outer lane LnO or the area extending from the outer lane LnO during reversing.

The route planning unit 77 determines in S241 whether the U-turn planned location UL is the intersection IA. If the U-turn planned location UL is the intersection IA (S241: YES), the route planning unit 77 sets the offset amount of the host vehicle Am within the turn-origin lane LnS to “large” in S242. On the other hand, if the U-turn planned location UL is a connecting road CL or the like (S241: NO), the route planning unit 77 sets the offset amount of the host vehicle Am within the turn-origin lane LnS to “small” in S243. The route planning unit 77, reflecting the settings from S242 or S243, generates a planned travelling path in S244 that offsets the host vehicle Am to the outer edge EO within a range that does not veer into the outer lane LnO.

### Summary of Second Embodiment

In the second embodiment described up to this point, similar to the first embodiment, the implementation of the U-turn notification process (see FIG. 13) ensures that the route guidance notification, when U-turn control is planned to be executed, differs from the notification when U-turn control is not planned to be executed. As a result, the same effects as the first embodiment are achieved, and it becomes possible to alleviate the anxiety of the occupants when U-turn control is performed.

In addition, in the second embodiment, if a reroute occurs that changes the route set for the host vehicle Am, an inquiry regarding whether to permit the execution of U-turn control after the reroute is conducted with the occupants of the host vehicle Am. By allowing the occupants to decide whether to permit U-turn control in this manner, it is possible to avoid situations where the occupants may feel significant anxiety due to U-turns in scenarios where they are more likely to feel uneasy after a reroute.

Additionally, in the second embodiment, if there is a recommended U-turn location that meets the recommended conditions for U-turn control on the route after a reroute, the execution of U-turn control at this recommended U-turn location is proposed to the occupants. This makes it easier to execute U-turn control at the planned U-turn location UL, where the execution of U-turn control is straightforward and unlikely to cause anxiety. As a result, U-turn control is more likely to be carried out based on the occupants' decision. As a result, the convenience for the occupants can be further enhanced.

Furthermore, in the second embodiment, when U-turn control is executed from the turn-origin lane LnS to the turn-destination lane LnG, the level of autonomous driving for the U-turn control is set to the level of autonomous driving permitted in the turn-destination lane LnG. As a result, the change in the level of autonomous driving is made before the U-turn control begins. Therefore, a situation where the autonomous driving level is changed during the high-load U-turn or after entering the turn-destination lane LnG, which could easily cause anxiety for the occupants, can be avoided.

Additionally, in the second embodiment, the level of autonomous driving in the travel control function is lowered to the level permitted in the turn-destination lane LnG while traveling in the turn-origin lane LnS. As a result, the handover from the autonomous driving system 50 to the driver can be completed in the turn-origin lane LnS. As a result, the situation where the autonomous driving level is lowered during the U-turn or after entering the turn-destination lane LnG, causing the behavior of the host vehicle Am to become unstable, is avoided.

In the second embodiment, the requirement for the driver to hold the steering wheel is modified according to the control load of the U-turn control. In this manner, by appropriately imposing the requirement and having the driver hold the steering wheel, it is possible to alleviate the passengers' anxiety during the U-turn. Additionally, if the requirement to hold the steering wheel is imposed when the U-turn becomes high-load due to the occurrence of a multi-point turn, the passengers' anxiety can be further alleviated. In the above second embodiment, the steering wheel corresponds to the “steering operation unit.”

Furthermore, in the second embodiment, the rear vehicle traveling behind the host vehicle Am is detected. Then, the planned travelling path of the host vehicle Am during the U-turn control is modified according to the presence or absence of the rear vehicle. As a result, the situation where the host vehicle Am performing the U-turn control excessively approaches the rear vehicle can be avoided. As a result, the anxiety of the occupants can be alleviated when U-turn control is performed even in scenarios where a rear vehicle is present.

Additionally, in the second embodiment, the criteria for determining whether to permit the execution of U-turn control are modified according to the level of autonomous driving intended to be applied to the U-turn control. In this way, if the implementation criteria for U-turn control are adjusted according to the level of autonomous driving, the anxiety of the occupants caused by the U-turn control can be more appropriately alleviated.

In the second embodiment, the higher the level of autonomous driving, the more likely the execution of U-turn control is to be permitted. Therefore, U-turn control is actively performed in scenarios where occupants are less likely to feel anxious. As a result, the convenience for the occupants provided by U-turn control can be further enhanced.

Furthermore, in the second embodiment, the planned travelling path of the host vehicle Am during U-turn control is modified according to the level of autonomous driving intended to be applied for the U-turn control. In this way, if the planned travelling path during U-turn control is adjusted according to the level of autonomous driving, it becomes easier to perform U-turns with behavior that is less likely to cause anxiety for the occupants.

Additionally, in the second embodiment, as the level of autonomous driving increases, a planned travelling path that does not require any multi-point turn is established. For example, in a driving control state at autonomous driving level 3, where the driver is not obligated to monitor the surroundings, the driver does not recognize the situation around the vehicle. Therefore, if multi-point turn occurs, the occupants are likely to feel anxious. Thus, when high-level autonomous driving is executed, avoiding the occurrence of multi-point turn can effectively suppress the occupants' anxiety.

### Third Embodiment

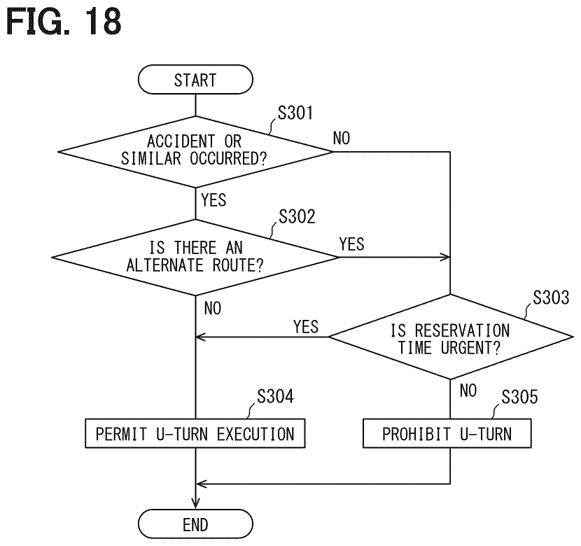

A third embodiment of the present disclosure is another modification of the first embodiment. In the autonomous driving ECU 50b of the third embodiment, U-turn control is not implemented as a general rule. The autonomous driving ECU 50b permits the execution of U-turn control only under predetermined conditions based on the restriction lifting process. Hereinafter, details of the restriction lifting process executed by the autonomous driving ECU 50b in the third embodiment will be described with reference to FIG. 1 and FIG. 2, based on FIG. 18.

### (Restriction Lifting Process for U-Turn Control)

The restriction lifting process shown in FIG. 18 is a process that temporarily lifts the prohibition on U-turn control. According to the restriction lifting process, the execution of U-turn control is permitted exclusively in emergency situations. The restriction lifting process is initiated by the autonomous driving ECU 50b based on the activation of driver assistance control or autonomous driving control in the autonomous driving system 50. The restriction lifting process is repeatedly executed by the autonomous driving ECU 50b until both the driver assistance control and autonomous driving control are turned off.

In S301 of the restriction lifting process, the road recognition unit 75 acquires traffic congestion information and traffic regulation information received via the in-vehicle communication device 39. In S301, the road recognition unit 75 determines whether a traffic obstruction, such as an accident or congestion, has occurred on the planned route. If a traffic obstruction has occurred (S301: YES), the route planning unit 77, in coordination with the navigation ECU 38, determines in S302 whether there is an alternative route to reach the destination (DST; see FIG. 3) that bypasses the location of the traffic obstruction. If an alternative route cannot be set (S302: NO), the action determination unit 63 permits the execution of a U-turn control in S304. In this manner, if the destination DST cannot be reached without performing U-turn control, the action determination unit 63 executes the U-turn control.

If no traffic obstruction has occurred (S301: NO) or if an alternative route can be set (S302: YES), the action determination unit 63 modifies the setting for permitting the execution of U-turn control according to the degree of urgency of the planned time. In this case, the action determination unit 63 determines whether the planned time is urgent based on the positional relationship between the destination DST set for the host vehicle Am and its current position, as well as the time relationship between the planned arrival time at the destination DST and the current time. The planned arrival time may be the time input by the passenger when the destination DST is set, or it may be the time presented to the passenger by the autonomous driving system 50 when the destination DST is set. Additionally, if the host vehicle Am is a service vehicle providing mobility services, the planned arrival time may also be the time presented to the user, who will be the passenger, at the time of the ride reservation. The ride reservation may also be referred to as a boarding reservation.

The action determination unit 63 determines that the planned time is not urgent (S303: NO) if it is estimated that the host vehicle Am can reach the destination DST by the planned arrival time even without executing U-turn control. In this case, the action determination unit 63 prohibits the execution of U-turn control in S305. On the other hand, if it is estimated that the host vehicle Am will not reach the destination DST by the planned arrival time without executing U-turn control, the action determination unit 63 determines that the planned time is urgent (S303: YES). In this case, the action determination unit 63 permits the execution of U-turn control in S304.

The determination of the urgency of the planned time in S303 may be carried out continuously or may be performed for a limited period. For example, the determination of the urgency of the planned time may start when the vehicle reaches a specified distance (e.g., several kilometers) from the destination DST or when the time remaining until the planned arrival time is within a specified period (e.g., 10 to 20 minutes). Furthermore, the determination of the urgency of the planned time may be performed only once or multiple times at the timing of the initial route search and decision by the navigation ECU 38.

### Summary of Third Embodiment

In the third embodiment described so far, similar effects to those of the first embodiment are achieved, and it becomes possible to alleviate the anxiety of passengers in cases where U-turn control is performed.

In addition, in the third embodiment, if it is possible to reach the destination DST without performing U-turn control, the execution of U-turn control is avoided. On the other hand, if the destination DST cannot be reached without performing U-turn control, U-turn control is executed. According to the above, in situations where there is no route to the destination DST due to accidents or other reasons, and the destination DST can only be reached by making a U-turn, the U-turn is permitted. Thus, if the system is set to basically avoid executing U-turn control, the anxiety of passengers caused by U-turn control can be alleviated. Furthermore, by limiting the execution of U-turn control to emergencies, it is possible to improve passenger convenience while gaining their acceptance of the U-turn.

In the third embodiment, the setting of whether to permit the execution of U-turn control is changed based on at least one of the positional relationship between the destination DST set in the host vehicle Am and the current position, and the time relationship between the planned arrival time at the destination DST and the current time. According to the above, in situations where the reserved time is approaching and there is a need to hurry to the destination DST, a route that includes U-turn control can be temporarily selected. In this way, by limiting the execution of U-turn control to emergencies, it is possible to enhance passenger convenience while gaining their acceptance of the U-turn.

### Other Embodiments

While several embodiments have been described above, the present disclosure is not limited to these embodiments. Various embodiments and combinations can be applied without departing from the scope of the present disclosure.

The processes in the above embodiments were mainly carried out by the autonomous driving ECU 50b. On the other hand, in Modification Example 1 of the above embodiments, the HMI control unit 100 mainly performs the inquiry process and U-turn notification process. Specifically, in the U-turn notification process of Modification Example 1, the information coordination unit 82 collaborates with the autonomous driving ECU 50b to understand the travelling plan of the host vehicle Am used by the driving control function. Furthermore, the presentation control unit 88 switches the display mode of the host vehicle status StA and provides the U-turn route guidance in a manner different from the right-turn route guidance or other route guidance. In this Modification Example 1, the HMI control unit 100 corresponds to the “vehicle controller,” the information coordination unit 82 corresponds to the “plan recognition unit,” and the presentation control unit 88 corresponds to the “notification execution unit.”

In Modification Example 2 of the above embodiments, the functions of the autonomous driving ECU 50b and the HMI control unit 100 are implemented in a single integrated ECU. The integrated ECU is equipped with both the driving control function related to autonomous driving and the integrated control function for presenting information to the passengers. In this Modification Example 2, the integrated ECU corresponds to the “vehicle controller,” and the presentation control unit 88 corresponds to the “notification execution unit” instead of the notification request unit 72.

Furthermore, the autonomous driving ECU 50b and the HMI control unit 100 may cooperate to perform the processing of the above embodiments. In such a modification example, the system including the autonomous driving ECU 50b and the HMI control unit 100 corresponds to the “vehicle controller,” and the presentation control unit 88 corresponds to the “notification execution unit.”

The functions of the driving assistance ECU 50a may be implemented in the autonomous driving ECU 50b or the integrated ECU. That is, the driving assistance ECU 50a, which implements driving control functions for autonomous driving level 2 or lower, may be omitted. Furthermore, the autonomous driving system 50 may be configured to implement only driving assistance control for autonomous driving level 2 or lower.

In Modification Example 3 of the above embodiment, as a mode change of the host vehicle status StA associated with the implementation of U-turn control, only the movement of the virtual viewpoint position to a higher and farther location is performed, while emphasizing the planned trajectory icon IPP is not performed. Additionally, in Modification Example 4 of the above embodiment, as a mode change of the host vehicle status StA associated with the implementation of U-turn control, only the emphasis of the planned trajectory icon IPP is performed. As in Modification Examples 3 and 4, the specific methods for mode changes associated with the implementation of U-turn control may be appropriately modified. Furthermore, for route guidance notifications associated with the implementation of U-turn control, voice messages or notification sounds played by the audio device 24 may be utilized.

In Modification Example 5 of the above embodiment, offset control is not implemented in at least one of the scenes involving U-turn control at the intersection IA or U-turn control outside the intersection IA. Additionally, in Modification Example 6 of the above embodiment, the offset amount in U-turn control at the intersection IA is made smaller than the offset amount in U-turn control outside the intersection IA.

In Modification Example 7 of the above embodiment, the emphasis on notifications in U-turn control without a temporary stop is omitted. Additionally, in Modification Example 8 of the above embodiment, even if no multi-point turn is performed, if a U-turn is made very tightly, in other words, if the vehicle gets excessively close to the outer edge of the turn-destination lane LnG, an around-view display is implemented. In this case, it is possible to additionally display a peripheral camera image AV that shows the outer edge of the turn-destination lane LnG.

In Modification Example 9 of the above embodiment, the multi-point turn of the host vehicle Am is performed at the timing when it approaches the outer edge of the turn-destination lane LnG. As in Modification Example 9, the timing for starting the multi-point turn may be appropriately adjusted considering the traffic environment and other factors.

In Modification Example 10 of the above embodiment, options such as “actively perform,” “perform,” “rarely perform,” and “do not perform” are provided for U-turn control. The occupant selects one of these options. As a result, U-turn control may be implemented only in scenarios where the occupant is less likely to feel anxious.

In Modification Example 11 of the above embodiment, if the occupant changes the destination, an inquiry for permission to execute U-turn control is made after rerouting. In contrast, if the navigation ECU 38 automatically changes the route due to the occurrence of a traffic obstruction, no inquiry for permission to execute U-turn control is made. As described above, the inquiry for permission to execute U-turn control may be carried out only when a specific reroute occurs.

In Modification Example 12 of the above embodiment, control is implemented to raise the level of autonomous driving during U-turn control to the level permitted in the target lane before entering the turn-destination lane LnG. Specifically, the control switching unit 78 switches the control state from hands-off level 2 to autonomous driving level 3 before or during the U-turn control.

In Modification Example 13 of the above embodiment, if autonomous driving level 3 is not permitted in the turn-destination lane LnG, the autonomous driving level during U-turn control is set to hands-off level 2 (or hands-on level 2) regardless of whether a multi-point turn is involved in the U-turn control. Additionally, in Modification Example 14 of the above embodiment, when a multi-point turn is required for U-turn control, the control transitions to hands-off level 2. When a multi-point turn is not required for U-turn control, the control transitions to hands-on level 2.

In Modification Example 15 of the above embodiment, the criteria for permitting the execution of U-turn control are adjusted such that the higher the autonomous driving level intended for U-turn control, the more difficult it becomes to permit the execution of the U-turn control. Additionally, in Modification Example 16 of the above embodiment, the intended travelling path of the host vehicle Am during U-turn control is set such that the lower the autonomous driving level intended for U-turn control, the less likely a multi-point turn will be required.

The U-turn route guidance in the above embodiment may be information provided only when autonomous driving control level 3 or higher is being implemented, or it may be information provided only when driving assistance control level 2 or lower is being implemented.

In the above embodiment, each function provided by the autonomous driving ECU and the HMI control unit can be provided by software and the hardware that executes each function, by software alone, by hardware alone, or by a combination of these. Furthermore, when such functions are provided by electronic circuits as hardware, each function can be provided by digital circuits that include numerous logic circuits or by analog circuits. Additionally, the software for realizing such functions may include, at least in part, code that is automatically generated by a neural network or language model trained using real-world camera images, for example.

Each processing unit in the above embodiment is hardware for computational processing, coupled with RAM. The processing unit includes at least one computational core such as a CPU (Central Processing Unit) and a GPU (Graphics Processing Unit). The processing unit may further include an FPGA (Field-Programmable Gate Array), an NPU (Neural network Processing Unit), and other IP cores with dedicated functions. Such processing units may be individually mounted on a printed circuit board, or they may be implemented in an ASIC (Application Specific Integrated Circuit) or FPGA.

The form of the storage medium (non-transitory tangible computer-readable medium) that stores various programs in the above embodiment may be modified as appropriate. Furthermore, the storage medium is not limited to a configuration provided on a circuit board; it may be provided in the form of a memory card or other format, inserted into a slot, and electrically connected to a control circuit such as an autonomous driving ECU. Additionally, the storage medium may be an optical disk, hard disk drive, or solid-state drive, which serves as the source or distribution medium for copying programs to an autonomous driving ECU or similar device.

The vehicle equipped with the above autonomous driving system and HMI system is not limited to general private passenger cars; it may also be a rental car, a vehicle for manned taxis, a ride-sharing vehicle, a cargo vehicle, or a bus. The vehicle equipped with the autonomous driving system and HMI system may be a right-hand drive vehicle or a left-hand drive vehicle. Furthermore, the traffic environment in which the vehicle operates may be based on left-hand traffic or right-hand traffic. The vehicle control according to the present disclosure may be appropriately optimized in accordance with the road traffic laws of each country and region, as well as the steering wheel position of the vehicle.

The control unit and methods described in the present disclosure may be implemented by a dedicated computer, which constitutes a processor programmed to execute one or more functions embodied by a computer program. Alternatively, the device and methods described in the present disclosure may be implemented by dedicated hardware logic circuits. Alternatively, the device and methods described in the present disclosure may be implemented by one or more dedicated computers, which are constituted by a combination of a processor executing a computer program and one or more hardware logic circuits. Additionally, the computer program may be stored as instructions executable by a computer on a non-transitory, computer-readable tangible recording medium.

In the present disclosure or the claims, the term “processor” may refer to a single hardware processor or several hardware processors that are configured to execute processing defined by computer program code (i.e., one or more instructions of a computer program) by sequentially reading the computer program code included in a computer program. In other words, a “processor” is a hardware device that executes one or more program processes. Therefore, the computer program code can be considered software that defines the processing of the processor according to its content. The “processor” may be a general-purpose or specific-purpose processor, such as, CPU (Central Processing Unit), a microprocessor, GPU (Graphics Processing Unit) and DFP (Data Flow Processor), but is not limited to these examples.

In the present disclosure or the claims, the term “memory” is a non-transitory tangible storage medium and may refer to a single or several hardware memories configured to store computer program code and/or data in a manner accessible by the processor. The “memory” may be implemented using any suitable memory technology, such as SRAM (Static Random-access Memory), SDRAM (Synchronous Dynamic RAM), nonvolatile/flash memory, or other types of memory. The computer program code that constitutes the program is stored on the memory and, when executed by a processor, causes the processor to realize the various functions described above.

In the present disclosure or the claims, the term “circuit” refers to a single hardware logic circuit or several hardware logic circuits (in other words, “circuitry”) that are configured to execute specific processing defined based on a pre-designed circuit configuration. In other words (and in contrast to the “processor”), the term “circuit” in the present disclosure or the claims refers to a hardware device that executes specific processing based on a circuit configuration, not processing defined by software such as the above-described computer program code. For instance, “circuit” may include a custom IC (Integrated Circuit) such as ASIC (Application Specific Integrated Circuit) or FPGA (Field Programmable Gate Array) designed using a hardware description language (HDL). That is, the term “circuit” in the present disclosure or the claims includes all hardware circuits except the above-described processor that executes processing by reading computer program code.

In the present disclosure or the claims, the phrase “at least one of a circuit and a processor” should be interpreted disjunctively (logical OR) and should not be interpreted as at least one circuit and at least one processor. Therefore, in the present disclosure or the claim, “at least one of a circuit and a processor is configured to cause the vehicle controller to execute functions” includes the case where only the circuit causes the vehicle controller to execute all the functions. Additionally, “at least one of a circuit and a processor is configured to cause vehicle controller to execute functions” includes the case where only the processor causes vehicle controller to execute all the functions. Furthermore, “at least one of a circuit and a processor is configured to cause the vehicle controller to execute functions” includes the case where the circuit causes vehicle controller to execute some of the functions and the processor causes the vehicle controller to execute the remaining functions. In the last case, for instance, if the vehicle controller executes functions A to C, functions A and B may be implemented by the circuit, and the remaining function C may be implemented by the processor.

What is claimed is:

1. A vehicle controller adapted to a host vehicle equipped with a driving control function that supports or substitutes for a driver in a driving operation of the host vehicle, the vehicle controller comprising:
at least one of (i) a circuit and (ii) a processor with a memory storing computer program code executable by the processor, the at least one of the circuit and the processor configured to:
acquire a driving plan of the host vehicle that is utilized by the driving control function; and
execute a route guidance notification in different modes when U-turn control is scheduled in the driving plan, compared to when the U-turn control is not scheduled in the driving plan.

2. The vehicle controller according to claim 1, wherein
the at least one of the circuit and the processor is further configured to execute the route guidance notification in an emphasized manner when the U-turn control is scheduled, compared to when the U-turn control is not scheduled.

3. The vehicle controller according to claim 1, wherein
the at least one of the circuit and the processor is further configured to:
recognize whether a scheduled U-turn location is at an intersection, the scheduled U-turn location being where the U-turn control is scheduled;
execute the U-turn control; and
modify a content of the U-turn control, according to whether the scheduled U-turn location is at the intersection.

4. The vehicle controller according to claim 3, wherein
the at least one of the circuit and the processor is further configured to control the host vehicle to move closer to an outer edge of a starting lane on a condition that the control execution unit executes the U-turn control in which the host vehicle U-turns from the starting lane to a destination lane, and
the outer edge of the starting lane is one of edges of the starting lane farther from the destination lane than another of the edges.

5. The vehicle controller according to claim 4, wherein
the at least one of the circuit and the processor is further configured to control the host vehicle to move closer to the outer edge when the scheduled U-turn location is at the intersection, as compared to when the scheduled U-turn location is not at the intersection.

6. The vehicle controller according to claim 1, wherein
the at least one of the circuit and the processor is further configured to change a type of the route guidance notification depending on whether the host vehicle makes a temporary stop during the U-turn control.

7. The vehicle controller according to claim 6, wherein
the at least one of the circuit and the processor is further configured to execute the route guidance notification in an emphasized manner when the temporary stop is not performed during the U-turn control, compared to when the temporary stop is performed.

8. The vehicle controller according to claim 1, wherein
the at least one of the circuit and the processor is further configured to change a type of the route guidance notification depending on whether the host vehicle performs maneuvering correction during the U-turn control.

9. The vehicle controller according to claim 8, wherein
the at least one of the circuit and the processor is further configured to provide broader situational awareness of surroundings of the host vehicle in the route guidance notification when the maneuvering correction is performed during the U-turn control, compared to when no maneuvering correction is performed.

10. The vehicle controller according to claim 8, wherein
the at least one of the circuit and the processor is further configured to:
execute the U-turn control;
determine whether the host vehicle is stuck during the U-turn control that has been started; and
start the maneuvering correction from a location where the host vehicle is determined to be stuck.

11. The vehicle controller according to claim 1, wherein
the at least one of the circuit and the processor is further configured to:
acquire a permission for the U-turn control from an occupant of the host vehicle; and
execute the U-turn control on a condition that the permission acquisition unit acquires the permission for the U-turn control from the passenger.

12. The vehicle controller according to claim 11, wherein
the at least one of the circuit and the processor is further configured to notify the passenger of number of times the host vehicle requires maneuvering correction for the U-turn control, as information for the passenger to determine whether to permit the U-turn control.

13. The vehicle controller according to claim 11, wherein
the at least one of the circuit and the processor is further configured to:
execute the U-turn control that requires maneuvering correction only on a condition that the permission is granted by the passenger; and
execute the U-turn control that does not require the maneuvering correction even without the permission granted by the passenger.

14. The vehicle controller according to claim 1, wherein
the at least one of the circuit and the processor is further configured to inquire of a passenger of the host vehicle whether to permit the U-turn control when a reroute occurs, and
the reroute is a process that modifies a path set for the host vehicle.

15. The vehicle controller according to claim 14, wherein
the at least one of the circuit and the processor is further configured to propose to the passenger execution of the U-turn control at a recommended U-turn location, on a condition that the recommended U-turn location is present on a rerouted path acquired by the reroute, and
the recommended U-turn location is a location that satisfies a recommended condition for the U-turn control.

16. The vehicle controller according to claim 1, wherein
the at least one of the circuit and the processor is further configured to:
avoid the U-turn control on a condition that the U-turn control is not required for the host vehicle to reach a destination set for the host vehicle; and
execute the U-turn control on a condition that the U-turn control is required for the host vehicle to reach the destination.

17. The vehicle controller according to claim 1, wherein
the at least one of the circuit and the processor is further configured to:
execute the U-turn control; and
set an autonomous driving level for the U-turn control to a permitted autonomous driving level that is allowed in a destination lane, on a condition that the control execution unit executes the U-turn control in which the host vehicle U-turns from a starting lane to the destination lane.

18. The vehicle controller according to claim 17, wherein
the at least one of the circuit and the processor is further configured to lower the autonomous driving level of the driving control function to the permitted autonomous driving level that is allowed on the destination lane, when the vehicle is travelling on the starting lane.

19. The vehicle controller according to claim 17, wherein
the at least one of the circuit and the processor is further configured to adjust an obligation for the driver to hold a steering operation unit according to a control load of the U-turn control.

20. The vehicle controller according to claim 1, wherein
the at least one of the circuit and the processor is further configured to execute a notification that prompts the driver to monitor surroundings of the host vehicle on a condition that the U-turn control is executed.

21. The vehicle controller according to claim 1, wherein
the at least one of the circuit and the processor is further configured to:
recognize whether a rear vehicle is travelling behind the host vehicle;
execute the U-turn control; and
modify a scheduled driving path of the host vehicle under the U-turn control, based on whether the target recognition unit recognizes presence of the rear vehicle.

22. The vehicle controller according to claim 1, wherein
the at least one of the circuit and the processor is further configured to:
execute the U-turn control; and
determine whether to allow the host vehicle to veer into an outer lane on a condition that the U-turn control in which the host vehicle U-turns from a starting lane to a destination lane is executed, and
the starting lane is between the outer lane and the destination lane.

23. The vehicle controller according to claim 1, wherein
the at least one of the circuit and the processor is further configured to:
execute the U-turn control; and
modify criteria for permitting the U-turn control based on an autonomous driving level scheduled to be used during the U-turn control.

24. The vehicle controller according to claim 23, wherein
the at least one of the circuit and the processor is further configured to lower the criteria for permitting the U-turn control as the autonomous driving level increases.

25. The vehicle controller according to claim 1, wherein
the at least one of the circuit and the processor is further configured to:
execute the U-turn control; and
modify a scheduled driving path of the host vehicle under the U-turn control, according to an autonomous driving level that is scheduled to be used during the U-turn control.

26. The vehicle controller according to claim 25, wherein
the at least one of the circuit and the processor is further configured to set the scheduled driving path that does not require maneuvering correction as the autonomous driving level increases.

27. The vehicle controller according to claim 1, wherein
the at least one of the circuit and the processor is further configured to:
execute the U-turn control; and
modify a setting for permitting the U-turn control based on at least one of
a positional relation between a present location of the host vehicle and a destination that is set for the host vehicle, or
a time relation between a present time and a scheduled arrival time at the destination.

28. A vehicle control method for controlling a host vehicle equipped with a driving control function that supports or substitutes for a driver in a driving operation of the host vehicle, the vehicle control method, which is executed by at least one processor, comprising:
recognizing a driving plan of the host vehicle that is utilized by the driving control function; and
executing a route guidance notification in different modes when U-turn control is scheduled in the driving plan, compared to when the U-turn control is not scheduled in the driving plan.

29. A non-transitory computer readable storage medium storing a program comprising instructions configured to, when executed by at least one processor, cause the at least one processor to:
recognize a driving plan of a host vehicle that is utilized by a driving control function included in the host vehicle, the driving control function being a function that supports or substitutes for a driver in a driving operation of the host vehicle; and
execute a route guidance notification in different modes when U-turn control is scheduled in the driving plan, compared to when the U-turn control is not scheduled in the driving plan.
